(19) United States
(12) Patent Application Publication
(10) Pub. No.: US 2010/0192814 A1
(43) Pub. Date: Aug. 5, 2010

(54) PROCESS FOR PRODUCING ANTISTATICALLY TREATED ARTIFICIAL STONE FOR FLAT STRUCTURES

(75) Inventors: Harald Herzog, Karlstein (DE); Peter Schwab, Essen (DE); Matthias Naumann, Greensboro, NC (US)

Correspondence Address: FROMMER LAWRENCE & HAUG, 745 FIFTH AVENUE- 10TH FL., NEW YORK, NY, 10151, US

(73) Assignee: Evonik Goldschmidt GmbH, Essen (DE)

(21) Appl. No.: 12/700,826

(22) Filed: Feb. 5, 2010

(30) Foreign Application Priority Data
Feb. 5, 2009 (DE) 10200900641.9

(51) Int. Cl. A47B 13/08; B32B 5/00; C08L 83/04

(52) U.S. Cl. 108/161; 428/220; 524/588

(57) ABSTRACT

An artificial stone for flat structures having antistatic properties, which contains ionic liquids or solutions of metal salts in ionic liquids as antistatic component, its use and a process for producing it.

This application claims benefit under 35 U.S.C. 119(a) of German patent application DE 10 2009 000641.9, filed on 5 Feb. 2009.

Any foregoing applications, including German patent application DE 10 2009 000641.9, and all documents cited therein or during their prosecution (“application cited documents”) and all documents cited or referenced in the application cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention.

In general, flat structures are electrical insulators on which high surface charges can accumulate during production, processing and use of articles produced therefrom.

For the purposes of the present invention, artificial stone configured as flat structures includes all articles having at least one (visible) face serving as surface which are suitable, for example in the form of tiles and/or other floor, wall, table or ceiling coatings, for producing a solid, sheet-like coating on a substrate.

Static charges lead to undesirable effects and serious hazard situations which range from attraction of dust, adherence of hygienically problematical contaminants, destruction of electronic components as a result of arcing, physiologically unpleasant electric shocks, ignition of flammable liquids in containers or pipes in which these are stirred, poured, conveyed or stored through to dust explosions, for example when transferring from dust-filled large containers. The undesirable electrostatic accumulation of dust on the surface of lining materials and coating materials can lead, under the action of mechanical stresses, to more rapid scratching and thus a shorter useful life of the consumer articles.

There is therefore great interest in preventing static charges on these materials or reducing the charges to a non-hazardous level.

A generally employed method for making it possible for charges to be conducted away and to minimise static charging is the use of coatings in the form of antistatic agents, i.e. non-ionic or ionic surface-active compounds and in particular ammonium and alkali metal salts, which are used essentially in the form of external and internal antistatic agents.

External antistatic agents are applied as aqueous or alcoholic solutions to the surface of the coating materials by spraying, painting or dipping and subsequent drying in air. The antistatic film which remains is effective on virtually all surfaces but has the disadvantage that it is very easily and undesirably removed again by rubbing or liquid.

In contrast to the internal antistatic agents having antistatic molecules which continue to migrate out from the interior of the plastic polymer base of the coating materials, external antistatic agents do not have a long-term action because of the absence of a depot effect. For this reason, preference is given to using internal antistatic agents which are added, as far as possible, in pure form or in the form of concentrated formulations to the coating materials. After usually mechanical incorporation into the coating materials, the internal antistatic agents are homogeneously distributed so that they display their action throughout the resulting layer and are not only present at the interface to the air.

According to present-day understanding evidenced by experiments, the antistatic agents migrate continuously as a result of inherent incompatibility to the surfaces of the coating materials and accumulate there, or replace losses. They often have only a low interaction with the matrix, i.e. the interaction is sufficiently large for them not to separate out but not so strong as to avoid migration to the surface. The hydrophobic part remains in the coating materials and the hydrophilic part binds, for example, to water present in the atmosphere and forms a conductive layer which can conduct away charges to the atmosphere even at a few tens or hundreds of volts and not only at a dangerous level of some thousands of volts. This ensures that an effective amount of antistatic agents is present at the surface over a relatively long period of time.

However, the migration rate (diffusion rate) is a critical factor in this concept: if it is too large, structures (e.g. crystalline structures) which have a low energy and lose the ability to bind moisture and as a result significantly reduce the antistatic effect and produce undesirable greasy films on the surface can be formed, with all the associated aesthetic and processing disadvantages, with the effectiveness also being put at risk.

If the migration rate is too low, no effect or an effect which is insufficient within practical times is achieved.

For this reason, combinations of antistatic agents which migrate rapidly and slowly are already being used in order to achieve a sufficiently quick initial effect and also a long-term effect which lasts for weeks and months.

Typical coating materials which have not been antistatically treated have surface resistances in the range from 10¹⁴ to 10¹¹ ohm and can therefore build up voltages of up to 15 000 volt. Effective antistatic agents should therefore be able to reduce the surface resistances of the lining materials and coating materials to 10¹⁰ ohm or below.

In addition, it has to be taken into account that antistatic agents can influence the physical and technical properties of the polymeric lining materials and coating materials, for example surface flow, substrate wettability, substrate adhesion, sealing power and thermal stability. To minimise these effects, the antistatic agents should therefore be effective even at low concentrations. Typical amounts used in the case of antistatic agents employed nowadays are from 0.01 to 3% by weight.

Metal salts are known and effective antistatic agents. However, they have the disadvantage that they have to be dissolved before use to achieve homogeneous distribution in the lining materials and coating materials. Customary solvents are alcohols, ethers, esters, polyethers, cyclic ethers, cyclic esters, amides, cyclic amides, aromatic compounds or organic solvents in general. However, the solubility is sometimes very low, so that large amounts of solvent have to be used to achieve sufficiently effective use concentrations.

If these antistatic formulations are used in transparent or at least uncoloured lining materials and coating materials, they have the disadvantage that they can have an adverse effect on the optical properties of the end product.

In reactive multicomponent systems, for example in the production of reactive polyurethane coatings, any reactive groups present in the solvent or other constituents of the antistatic formulation can undesirably participate in the reaction and thus alter, in particular, the physical properties of the end product. In practice, the metal salts are therefore preferably dissolved in one of the formulation constituents; in the case of polyurethanes, this is generally the alcohol component, i.e. in diols or polyols which are then reacted with isocyanate components to form the polymer matrix. Owing to the large number of polyols which can be used, a correspondingly large number of solutions would then have to be provided. These antistatic agents/metal salts are therefore frequently dissolved in solvents which are constituents of all formulations, e.g. ethylene glycol, propylene glycol or other reactive organic solvents. This has the disadvantage that typically the total proportion of these formulation constituents, which are then used not only as reactive component in the polyurethane formulation but either additionally or exclusively as solvent in the antistatic formulation, in the polyurethane formulation must not be higher than would be the case without addition of the antistatic formulation, so that the physical properties of the end product are as far as possible not altered.

Attempts have already been made to provide solvents for metal salts which can be used universally and have a high solvent capability for many metal salts. In addition, they should be largely inert towards the reaction components or else be a constituent of the formulation or have no adverse effect on the physical properties of the end product. The new solvent should additionally have improved solvent characteristics for metal salts, and the resulting solution composed of solvent and metal salt should have better antistatic properties in coating materials.

For this purpose, use is made of particular ionic liquids which represent better solvents for many metal salts than the abovementioned diols and polyols and customary organic solvents. Significantly smaller amounts of solvent should be needed to introduce an effective content of metal salt into coating materials in order to improve the conductivity and produce effective antistatic formulations than in WO 2008/006422 (US 2008-0114105). This document prescribes the use of ionic liquids as solvents for metal salts, with organic solvents or dispersants being able to be additionally added to such mixtures in order to set a very high conductive salt content. These are used in exclusively low-viscosity systems such as printing inks and/or printing varnishes. Antistatic systems which could also be used in thick coatings and whose polymer matrix has a high proportion of particulate abraded solid (e.g. abraded marble) and are also used in other fields of use having different requirements are not disclosed in this document.

Conductive floors have to be able to conduct away static charges in a targeted manner; for this reason, use is generally made of specific system structures whose main constituents are, apart from a primer, a highly conductive surface coating and a topcoat through which charges can be conducted. The required ability for charges to be conducted through is achieved essentially by the use of carbon fibres. Finally, the conductive surface coating must still be connected to earth.

The so-called ESD floors are designed to avoid static charges as far as possible and conduct them away in a defined manner. These functions are checked not only by means of conventional electrode measurements but also by measurement of body voltage generation, the ability to conduct away charges from persons by means of a human being/shoe/floor/earth system measurement and via the charge decay time per person. Such ESD floors are built up like the conductive systems but are additionally provided with at least one thin-film surface-conductive sealing layer. It is also possible to additionally use surface-conductive topcoats, in which case the surface conductivity is produced by the use of conductive fillers and pigments. However, such systems are very expensive. In addition, the layer thickness tolerance of these coatings is generally very limited and the quaternary ammonium compounds which are also used therein are not sufficiently effective.

Both for the conductive floors and for the ESD floors, various binder systems are used as polymer matrix. Most common are amine-cured epoxy resins, aromatic and aliphatic polyurethane systems, free-radically crosslinking methacrylates (PMMA floors) and vinyl esters. To achieve the desired ESD properties, a high application outlay is required and expensive topcoats generally have to be applied.

DE 10 2006 015775 (US 2009-0068435) also describes antistatic formulations in the form of thick-layer floor coatings which are thus not suitable, as a thick coat forming a flexible floor coating, for particularly strong floors which have to meet demanding requirements.

In the light of the above-described disadvantages of the prior art, it is an object of the present invention to provide artificial stone for flat structures (e.g. of artificial marble) having antistatic properties. This should be achieved without use of additional sealing materials; without the layer thickness sensitivity which is known to be disadvantageous and naturally under economically advantageous conditions using, in particular, inexpensive raw materials.

It is also important that, since requirements of an aesthetic nature are pertinent because of use for floor, wall or table tile or slabs, electrostatic charges are conducted away as far as possible through a substance which does not adversely affect the choice of colour of the end product.

This object is achieved by artificial stone for flat structures which contains ionic liquids and/or solutions of metal salts in ionic liquids as antistatic components.

It has surprisingly been found that the object could be fully achieved by means of this system, and, in particular, scattering of conductivity values as a function of the layer thickness selected in each case can be completely avoided. In addition, the increasing proportions of conductivity holes (“dead spots”) which otherwise occur with increasing layer thickness do not occur. The artificial stone of the invention thus enables the otherwise disadvantageous layer thickness sensitivity to be avoided. In addition, it was not to be expected that the proposed artificial stone for flat structures could at the same time meet the requirements for the ability to conduct away charges and also for the ESD systems in a single flat structure. In this way, it is possible to produce, in a relatively inexpensive fashion, artificial stone for flat structures which no longer becomes significantly electrostatically charged, and it is also possible, depending on the respective field of use, to combine the inventive antistatic components with further conductive components in order to set the performance of the material in a targeted manner.

The surface resistance of the flat structures equipped according to the invention drops to below 10¹⁰ ohm.

The antistatically treated artificial stone of the invention for flat structures is based on the use of ionic liquids as antistatic and/or as solvent (compatibiliser) for metal salts (conductive salts), in particular alkali metal salts, with further organic solvents or dispersants being able to be added to these mixtures in order to set a very high conductive salt content.

The antistatic formulation comprising at least one ionic liquid and optionally at least one metal salt is generally added together with but not necessarily at the same time as the other constituents before curing of the polymer matrix. In the case of thermoplastic systems, the antistatic formulation and the abraded solid can also be incorporated after remelting.

The invention therefore provides a process in which the antistatic formulation comprising at least one ionic liquid and optionally at least one metal salt is kneaded together with the other constituents before curing of the polymer matrix or in the case of thermoplastic polymers is incorporated by melting.

The incorporation of the antistatic formulation is carried out by methods with which a person skilled in the art will be familiar in a manner analogous to the incorporation of other additives and auxiliaries into the polymer composite compositions.

The antistatically treated artificial stone of the invention for flat structures contains up to a maximum of 40% by weight, preferably up to 25% by weight, of a polymer matrix containing a polyurethane, epoxy resin, polyester resin, acrylate, methacrylate and/or vinyl ester. In addition, the polymers can also contain additions of vegetable constituents, in particular polysaccharides such as maize starch, soya bean starch, and fats.

Unlike thick floor coatings, the present invention provides for the constituent matrix of the artificial stone to comprise at least 60% by weight, preferably over 70% by weight, of abraded solid. The remainder is made up by the polymer matrix, the antistatic formulation and further additives and auxiliaries such as pigments, dyes, deaerators, etc.

The artificial stone claimed is not restricted to specific formulations containing the antistatic component in defined compounds. However, it is recommended to mix the antistatic component into the artificial stone in amounts ranging from 0.01 to 30% by weight and preferably from 0.1 to 20% by weight, based on the total mass of the formulation of the artificial stone.

The antistatic component used according to the invention consists of the ionic liquid alone or else of a mixture of the ionic liquid and a metal salt. In the case of the mixture of ionic liquid and metal salt, from 0.01 to 30 parts by weight of ionic liquid and/or from 0.1 to 30 parts by weight of metal salt, based on the total mass of the formulation for the flat structure, are used, with the metal salt always being used in combination with at least one ionic liquid. It is possible to use both mixtures of different metal salts and mixtures of various ionic liquids.

The proportion of metal salts in the total mixture of the antistatic formulation is preferably in the range from 0.1 to 50% by weight, particularly preferably from 0.5 to 20% by weight and very particularly preferably from 1 to 10% by weight.

As abraded solid, it is possible to use, according to the invention, solid, naturally occurring or artificially produced, if appropriate generally microscopically heterogeneous, compositions of minerals, abraded rock, rock fragments, glasses or residues of organisms, for example silica-containing algae, but also artificially produced rocks or else solid plastics. The abraded solid can also be used in any mixtures of the various components.

The antistatic formulation of the invention acts as an internal antistatic and can migrate out from the matrix of polymer and abraded solid to the surface, thus maintaining the antistatic action.

The term “solid” used here is used broadly and also relates to naturally occurring metal alloys, volcanic glass, loose sand or coal.

Rocks, and accordingly also abraded rock derived therefrom, comprise first and foremost minerals such as marble, quartz or granite. These are first and foremost silicates such as feldspars, quartz, mica, amphiboles or olivine, but carbonates, such as calcite or dolomite, are also important constituents of rocks. Apart from these main components (the mineral components which make up more than 10% by weight of the total mass), most rocks also contain secondary components (components which make up from 10 to 1% by weight) or accessories (components which are present in amounts of only <1% by weight). Accessories frequently give the rocks their names.

Natural rocks can be divided, according to the way in which they are formed (genesis), into three classes of rock: Magmatic rocks (magmatites), metamorphic rocks (metamorphites), sedimentary rocks (sedimentites).

Examples of rocks are achondrite, adakite, aleurite, alkaline granite, amphibolite, anatexite, andesite, anhydrite rock, anthracite, aplite, arenite, arizonite, arkose, eyed gneiss, basalt, basanite, bauxite, bentonite, pumice, biolites, foliated coal, blue slate, pea ore, brown coal, breccia, coloured sandstone, striated ore, charnockite, chert, Chile saltpetre, chlorite shale, chondrite, cipollino, roofing slate, dacite, diabase, diamictite, diatomite, diorite, dolerite, dolomite, dunite, iron meteorite, iron oolite, eclogite, enderbite, pisolite, essexite, evaporite, fanglomerate, faxe lime, fibrous coal, felsite, rock quartzite, fat coal, firestone, cake lava, flame coal, spotted shale, flint, flysch, foidite, foyaite, fruit shale, fulgurite, gabbro, sheaf shale, gas flame coal, gas coal, gypsum, shiny coal (hard coal), shiny coal (brown coal), glaucophane shale, mica shale, gneiss, granite, granite porphyry, granodiorite, granophyr, granulite, graptholite shale, greywacke, griffel shale, green shale, halitite, hard brown coal, harzburgite, hawaiite, hornblendite, hornfels, hornstone, humolite, ignimbrite, itacolumite, potassium salts, calcareous sandstone, limestone, lime-silicate rock, sintered lime, calcareous tuff, calciolite, cannel coal, kaolin, carbonatite, karst marble, cataclasite, kennel coal, khondalite, diatomaceous earth, kieselguhr, black jasper, sintered silica, kimberlite, cushion lava, klingstein, bone breccia, nodular shale, coal, coal ironstone, carbonaceous lime, cockade ore, conglomerate, contact shale, coral ore, chalk, kuckersite, lamproite, lamprophyr, lapilli, lapis lazuli, larvikite, lava, latite, clay, brick clay, leucitite, lherzolite, lignite, limburgite, liparite, liptobiolite, loose rock, loess, lutite, lydite, lean coal, mafitite, amygdaline rock, manganese nodules, marble, massive lime, matt coal, meerschaum, melaphyr also amygdaline rock, melilitite, marl, marl shale, marl stone, meteorite, migmatite, microdiorite, microgabbro, microgranite, minette (gangue), minette (ore), moldavite, monzonite, MORB, mugearite, mylonite, nepheline basalt, nephelinite, nepheline syenite, obsidian, OIB, oil shale, onyx marble, oolite, ophicalcite, ophiolite, ophite, opuka, pallasite, hard pitch, pantellerite, pegmatite, perlite, perovskite, phonolite, phyllite, picrite, ragstone, porphyry, prasinite, pseudotachylite, pyroxenite, quarzite, quarzolite, quartz porphyry, radiolarite, rapakiwi, bog iron ore, rhyolite, cockade ore, rogenstein, sandstone, wollastonite, slate, slag, black pelite, serpentinite, mudstone, skarn, weathered basalt, spathic iron ore, spiculite, spilite, hard coal, rock salt, stony meteorite, suevite, syenite, talc-disthene shale, tectite, tephrite, tholeiite, tonalite, clay shale, claystone, trachyte, travertine, trondhjemite, stalagmite, tuff, unakite, white shale, wustite.

Apart from these mainly natural rocks, it is also possible to make concomitant use of synthetically produced rocks or, for example, glass, porcelain and ceramic in comminuted form according to the invention for producing the flat structures.

Many solid, optionally impact-hard or impact-resistant plastics can be used in comminuted form either alone or in mixtures with rocks and/or synthetic rocks can be processed to give the flat structures according to the invention.

The natural types of rock, synthetic rocks, glasses, porcelain and/or ceramics and also solid plastics can be used either alone and/or in any mixtures with one another and among one another.

Furthermore, additives and auxiliaries such as fillers and/or pigments, which preferably have conductive properties, can be present. Possibilities here are, in particular, carbon fibres such as fibres based on polyacrylonitrile (PAN), pitch and Reyon®, graphite, carbon black, metal oxides and metal alloy oxides. Fillers and pigments coated with components which give them conductive properties are likewise suitable. In this case, too, in each case optionally conductively coated graphites, coated carbon blacks and coated metal oxides or coated metal alloy oxides are particularly suitable.

The abraded solid to be used to form the artificial stone and, if appropriate, also for the artificial stone adhesive, plaster, grouting mortar or tile adhesive has a particle size in the range from 0.001 mm to 20 mm, preferably from 0.01 mm to 5 mm.

The fully cured artificial stone comprising the abraded solid in the polymer matrix can, if desired, be ground and/or polished using methods known to those skilled in the art in order to be able to achieve an aesthetically desirable surface structure without the antistatic properties being adversely affected.

The artificial stone which has been antistatically treated according to the invention has a specific surface resistance of 10¹⁰ ohm and below and thus significantly below the surface resistances of thick floor coatings made of polymer which have not been antistatically treated.

The invention further also provides the adhesives and plasters utilised for adhesive bonding to the substrate; these may be treated in the same way with the antistatic formulations according to the invention. However, these components can additionally contain the abraded solid.

Ionic liquids are generally salts which melt at low temperatures (<100° C.) and represent a new class of liquids having a nonmolecular, ionic character. In contrast to classical salt melts which are high-melting, highly viscous and very corrosive media, ionic liquids are liquid at low temperatures and have a relatively low viscosity (K. R. Seddon J. Chem. Technol. Biotechnol. 1997, 68, 351-356).

For the purposes of the present invention, ionic liquids are salts of the general formulae (I), (II), or (III) listed below:

[A]ₙ⁺[Y]ⁿ⁻ (I)

where n is 1, 2, 3 or 4, [A]⁺ is a quaternary ammonium cation, an oxonium cation, a sulphonium cation or a phosphonium cation and [Y]ⁿ⁻ is a monovalent, divalent, trivalent or tetravalent anion; or
mixed salts of the general formulae (II)

[A¹]⁺[A²]⁺[Y]²⁻ (IIa);

[A¹]⁺[A²]⁺[A³]⁺[Y]³⁻ (IIb); or

[A¹]⁺[A²]⁺[A³]⁺[A⁴]⁺[Y]⁴⁻ (IIc),

where [A¹]⁺, [A²]⁺ [A³]⁺ and [A⁴]⁺ are selected independently from the groups mentioned for [A]⁺ and [Y]ⁿ⁻ has the meaning indicated for formula (I); or
mixed salts of the general formulae (III)

[A¹]⁺[A²]⁺[A³]⁺[M¹]⁺[Y]⁴⁻ (IIIa);

[A¹]⁺[A²]⁺[M¹]⁺[M²]⁺[Y]⁴⁻ (IIIb);

[A¹]⁺[M¹]⁺[M²]⁺[M³]⁺[Y]⁴⁻ (IIIc);

[A¹]⁺[A²]⁺[M¹]⁺[Y]³⁻ (IIId);

[A¹]⁺[M¹]⁺[M²]⁺[Y]³⁻ (IIIe);

[A¹]⁺[M¹]⁺[Y]²⁻ (IIIf);

[A¹]⁺[A²]⁺[M⁴]²⁺[Y]⁴⁻ (IIIg);

[A¹]⁺[M¹]⁺[M⁴]²⁺[Y]⁴⁻ (IIIh);

[A¹]+[M⁵]³⁺[Y]⁴⁻ (IIIi); or

[A¹]⁺[M⁴]²⁺[Y]³⁻ (IIIj),

where [A¹]⁺, [A²]⁺ and [A³]⁺ are selected independently from the groups mentioned for [A]⁺, [Y]ⁿ⁻ has the meaning indicated for formula (I) and [M¹]⁺, [M²]⁺, [M³]⁺ are monovalent metal cations, [M⁴]²⁺ is a divalent metal cation and [M⁵]³⁺ is a trivalent metal cation; or mixtures of all the formulae (I) to (III).

Ionic liquids comprise, for example, anions such as halides, carboxylates, phosphates, thiocyanates, isothiocyanates, dicyanamides, sulphates, alkylsulphates, sulphonates, alkylsulphonates, tetrafluoroborate, hexafluorophosphate or bis(trifluoromethylsulphonyl)imide combined with, for example, substituted ammonium, phosphonium, pyridinium or imidazolium cations, with the abovementioned anions and cations representing a small selection of the large number of possible anions and cations and therefore no claim to completeness being made or any restriction being implied.

The ionic liquids used according to the invention are preferably composed of at least one quaternary nitrogen and/or phosphorus compound and/or sulphur compound and at least one anion and their melting points are below about +250° C., preferably below about +150° C., in particular below about +100° C. The ionic liquids or mixtures thereof used according to the invention are particularly preferably liquid at room temperature.

The ionic liquids which are preferably used for the purposes of the invention can comprise, for example, at least one cation of the general formulae:

R¹R²R³R⁴N⁺ (IV)

R¹R²N⁺═CR³R⁴ (V)

R¹R²R³R⁴P⁺ (VI)

R¹R²P⁺═CR³R⁴ (VII)

R¹R²R³S⁺ (VIII)

where
R¹, R², R³, R⁴ are identical or different and are each hydrogen, a linear or branched aliphatic hydrocarbon radical which has from 1 to 30 carbon atoms and may contain double bonds, a cycloaliphatic hydrocarbon radical which has from 5 to 40 carbon atoms and may contain double bonds, an aromatic hydrocarbon radical having from 6 to 40 carbon atoms, an alkylaryl radical having from 7 to 40 carbon atoms, a linear or branched aliphatic hydrocarbon radical which has from 2 to 30 carbon atoms and is interrupted by one or more heteroatoms (oxygen, NH, NR′ where R′ is a C₁-C₃₀-alkyl radical which may contain double bonds, in particular —CH₃) and may contain double bonds, a linear or branched aliphatic hydrocarbon radical which has from 2 to 30 carbon atoms and is interrupted by one or more functions selected from the group consisting of —O—C(O)—, —(O)C—O—, —NH—C(O)—, —(O)C—NH, —(CH₃)N—C(O)—, —(O)C—N(CH₃)—, —S(O₂)—O—, —O—S(O₂)—, —S(O₂)—NH—, —NH—S(O₂)—, —S(O₂)—N(CH₃)—, —N(CH₃)—S(O₂)— and may contain double bonds, a linear or branched aliphatic or cycloaliphatic hydrocarbon radical which has from 1 to 30 carbon atoms and is terminally functionalised by OH, OR′, NH₂, N(H)R′, N(R′)₂, where R′ is a C₁-C₃₀-alkyl radical which may contain double bonds, and may contain double bonds, or a block or random polyether according to —(R⁵—O)ₙ—R⁶,
   where
   R⁵ is a linear or branched hydrocarbon radical containing from 2 to 4 carbon atoms,
   n is from 1 to 100, preferably from 2 to 60, and
   R⁶ is hydrogen, a linear or branched aliphatic hydrocarbon radical which has from 1 to 30 carbon atoms and may contain double bonds, a cycloaliphatic hydrocarbon radical which has from 5 to 40 carbon atoms that may contain double bonds, an aromatic hydrocarbon radical having from 6 to 40 carbon atoms, an alkylaryl radical having from 7 to 40 carbon atoms or a radical —C(O)—R⁷ where
   R⁷ is a linear or branched aliphatic hydrocarbon radical which has from 1 to 30 carbon atoms that may contain double bonds, a cycloaliphatic hydrocarbon radical which has from 5 to 40 carbon atoms and may contain double bonds, an aromatic hydrocarbon radical having from 6 to 40 carbon atoms, an alkylaryl radical having from 7 to 40 carbon atoms.

Preference is given to quaternary ammonium salts of alkoxylated fatty acids, also referred to as alkanolamine ester quats, characterized by the generic formula R¹R²R³R⁴N⁺A⁻ (IV) where R¹ is an alkyl radical having from 1 to 20 carbon atoms, R² is an alkyl radical having from 1 to 4 carbon atoms, R³ is a radical (CH₂CHRO)ₙ—H where n is from 1 to 200 and R is H or CH₃, R⁴ is an alkyl radical having from 1 to 4 carbon atoms or a radical (CH₂CHRO)ₙ—H where n is from 1 to 200 and R is H or CH₃ and A⁻ is a monovalent anion.

Among these compounds, preference is given to substances of the formula

R⁶₄₋ₘN⁺[((CH₂)ₙ-Q-R⁷]ₘX⁻ (IX)

where: each radical R⁶ is independently an alkyl group or hydroxyalkyl group having from 1 to 6 carbon atoms or a benzyl group and preferably a methyl group; the radicals R⁷ are each, independently of one another, hydrogen, a linear or branched alkyl group having from 11 to 22 carbon atoms, a linear or branched alkenyl group having from 11 to 22 carbon atoms, with the proviso that at least one radical R⁷ is not hydrogen;
the radicals Q are selected independently from the groups of the formulae —O—C O)—, —C(O)O, —NR⁸—C(O)—, —C(O)—NR⁸—, —O—C(O)—O, —CHR⁹—O—C(O)— or —CH(OCOR⁷)—CH₂—O—C(O)—, where R⁸ is hydrogen, methyl, ethyl, propyl or butyl and R⁹ is hydrogen or methyl, and Q is preferably —O—C(O)— or —NH—C(O)—; m is from 1 to 4 and preferably 2 or 3; n is from 1 to 4 and preferably 2; and X is an anion which is compatible with plasticisers, e.g. chloride, bromide, methylsulphate, ethylsulphate, sulphate or nitrate, preferably chloride or methylsulphate. The quaternary ammonium compounds can be mixtures of compounds containing different groups R⁷ which are not hydrogen and whose number extends from 1 up to m. Such mixtures preferably comprise an average of from 1.2 to 2.5 groups R⁷ which are not hydrogen. The proportion of groups R⁷ which are not hydrogen is preferably from 1.4 to 2.0 and more preferably from 1.6 to 1.9.

Preferred quaternary ammonium compounds are the compounds of the type:

R⁶N⁺[CH₂CHR⁹OH—][CH₂CHR⁹OC(O)R⁷]₂ X⁻ (X)

R⁶N⁺[CH₂CHR⁹OC(O)R⁷]₂ X⁻ (XI)

R⁶N⁺[CH₂CHR⁹OH—][CH₂CH₂NHC(O)R⁷]₂ X⁻, (XII)

where R⁶, R⁷ and X have the same meanings as defined above for formula (IX), with the proviso that R⁷ is not hydrogen. The fragment —C(O)R⁷ is preferably a fatty acyl group. Fatty acyl groups which can be used are derived from the natural sources of triglycerides, preferably tallow, vegetable oils, partially hydrogenated tallow and partially hydrogenated vegetable oils. Sources of triglycerides which can be used are soya bean oil, tallow, partially hydrogenated tallow, palm oil, palm kernels, rapeseeds, lard, coconut, oilseed rape, safflower oil, maize, rice and tall oil and mixture of these components.

A person skilled in the art will know that the composition of the fatty acid-containing compounds is subject to some natural fluctuations from harvest to harvest or as a function of the many sources of vegetable oil. The R⁷ groups are usually mixtures of linear and branched carbon chains of the saturated and unsaturated aliphatic fatty acids.

The proportion of unsaturated groups R⁷ in such mixtures is preferably at least 10%, particularly preferably at least 25% and very particularly preferably from 40% to 70%. The proportion of polyunsaturated groups R⁷ in such mixtures is less than 10%, preferably less than 5% and particularly preferably less than 3%. If necessary, a partial hydrogenation can be carried out to increase the saturated character and thus improve the stability (e.g. odour, colour, etc.) of the end product. The content of unsaturated components, expressed by the iodine number, should be in the range from 5 to 150 and preferably in the range from 5 to 50. The ratio of cis and trans isomers of the double bonds in the unsaturated groups R⁷ is preferably greater than 1:1 and particularly preferably in the range from 4:1 to 50:1.

Preferred examples of compounds of the formula (IX) are:
N,N-di(tallowyloxyethyl)-N,N-dimethylammonium chloride;
N,N-di(canolyloxyethyl)-N,N-dimethylammonium chloride;
N,N-di(tallowyloxyethyl)-N-methyl,N-(2-hydroxyethyl)ammonium methylsulphate;
N,N-di(canolyloxyethyl)-N-methyl,N-(2-hydroxyethyl)-ammonium methylsulphate;
N,N-di(tallowylamidoethyl)-N-methyl,N-(2-hydroxyethyl)-ammonium methylsulphate;
N,N-di(2-tallowyloxy-2-oxo-ethyl)-N,N-dimethylammonium chloride;
N,N-di(2-canolyloxy-2-oxo-ethyl)-N,N-dimethylammonium chloride;
N,N-di(2-tallowyloxyethylcarbonyloxyethyl)-N,N-dimethyl-ammonium chloride;
N,N-di(2-canolyloxyethylcarbonyloxyethyl)-N,N-dimethyl-ammonium chloride;
N(2-tallowyloxy-2-ethyl)-N-(2-tallowyloxy-2-oxo-ethyl)-N,N-dimethylammonium chloride;
N(2-canolyloxy-2-ethyl)-N(2-canolyloxy-2-oxo-ethyl)-N,N-di-methylammonium chloride;
N,N,N-tri(tallowyloxyethyl)-N-methylammonium chloride;
N,N,N-tri(canolyloxyethyl)-N-methylammonium chloride;
1,2-ditallowyloxy-3-N,N,N-trimethylammoniopropyl chloride; and
1,2-dicanolyloxy-3-N,N,N-trimethylammoniopropyl chloride.

More preferred quaternary ammonium salts are ditallowedimethylammonium chloride, ditallowedimethyl-ammoniumn methylsulphate, dimethylammonium chloride and di(hydrated-tallow)distearyldimethylammonium chloride and dibehenyldimethylammonium chloride.

Further possible cations are ions derived from saturated or unsaturated cyclic compounds or aromatic compounds which each have at least one trivalent nitrogen atom in a 4- to 10-membered, preferably 5- or 6-membered, heterocyclic ring which may optionally be substituted. Such cations can be described in simplified form (i.e. without indication of the precise position and number of the double bonds in the molecule) by the general formulae (XIII), (XIV) and (XV) below, where the heterocyclic rings may also contain a plurality of heteroatoms.

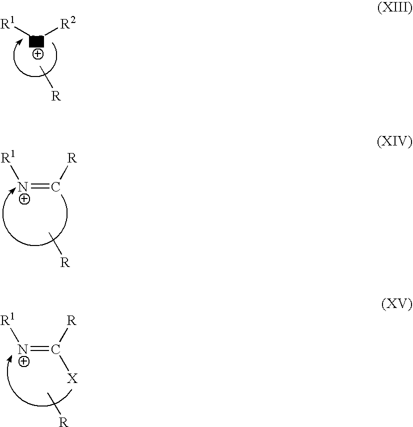

Here, R¹ and R² have the abovementioned meanings,
R is hydrogen, a linear or branched aliphatic hydrocarbon radical which has from 1 to 30 carbon atoms and may contain double bonds, a cycloaliphatic hydrocarbon radical which has from 5 to 40 carbon atoms and may contain double bonds, an aromatic hydrocarbon radical having from 6 to 40 carbon atoms or an alkylaryl radical having from 7 to 40 carbon atoms,
X is an oxygen atom, a sulphur atom or a substituted nitrogen atom (X═O, S, NR¹).

Examples of cyclic nitrogen compounds of the abovementioned type are pyrrolidine, dihydropyrrole, pyrrole, imidazoline, oxazoline, oxazole, thiazoline, thiazole, isoxazole, isothiazole, indole, carbazole, piperidine, pyridine, the isomeric picolines and lutidines, quinoline and isoquinoline. The cyclic nitrogen compounds of the general formulae (XIII), (XIV) and (XV) can be unsubstituted (R═H), monosubstituted or multiply substituted by the radical R, where in the case of multiple substitution by R, the individual radicals R may be different.

Further possible cations are ions derived from saturated acyclic, saturated or unsaturated cyclic compounds or aromatic compounds which each have more than one trivalent nitrogen atom in a 4- to 10-membered, preferably 5- or 6-membered, heterocyclic ring. These compounds can be substituted on the carbon atoms and/or on the nitrogen atoms. They can also be fused with optionally substituted benzene rings and/or cyclohexane rings to form polycyclic structures. Examples of such compounds are pyrazole, 3,5-dimethylpyrazole, imidazole, benzimidazole, N-methylimidazole, dihydropyrazole, pyrazolidine, pyridazine, pyrimidine, pyrazine, 2,3-, 2,5- and 2,6-dimethylpyrazine, cinnoline, phthalazine, quinazoline, phenazine and piperazine. Cations derived from imidazole and its alkyl and phenyl derivatives have been found to be particularly useful as constituents of ionic liquids.

Further possible cations are ions which contain two nitrogen atoms and are represented by the general formula (XVI)

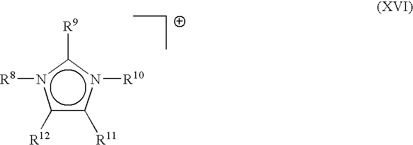

where
R⁸, R⁹, R¹⁰, R¹¹, R¹² are identical or different and are each hydrogen, a linear or branched aliphatic hydrocarbon radical which has from 1 to 30 carbon atoms and may contain double bonds, a cycloaliphatic hydrocarbon radical which has from 5 to 40 carbon atoms and may contain double bonds, an aromatic hydrocarbon radical having from 6 to 40 carbon atoms, an alkylaryl radical having from 7 to 40 carbon atoms, a linear or branched aliphatic hydrocarbon radical which has from 1 to 30 carbon atoms and is interrupted by one or more heteroatoms (oxygen, NH, NR′ where R′ is a C₁-C₃₀-alkyl radical which may contain double bonds) and may contain double bonds, a linear or branched aliphatic hydrocarbon radical which has from 1 to 30 carbon atoms and is interrupted by one or more functions selected from the group consisting of —O—C(O)—, —(O)C—O—, —NH—C(O)—, —(O)C—NH, —(CH₃)N—C(O)—, —(O)C—N(CH₃)—, —S(O₂)—O—, —O—S(O₂)—, —S(O₂)—NH—, —NH—S(O₂)—, —S(O₂)—N(CH₃)—, —N(CH₃)—S(O₂)— and may contain double bonds, a linear or branched aliphatic or cycloaliphatic hydrocarbon radical which has from 1 to 30 carbon atoms and is terminally functionalised by OH, OR′, NH₂, N(H)R′, N(R′)₂ where R′ is a C₁-C₃₀-alkyl radical which may contain double bonds, and may contain double bonds, or a block or random polyether made up of —(R⁵—O)ₙ—R⁶,
   where
   R⁵ is a hydrocarbon radical containing from 2 to 4 carbon atoms,
   n is from 1 to 100, and
   R⁶ is hydrogen, a linear or branched aliphatic hydrocarbon radical which has from 1 to 30 carbon atoms and may contain double bonds, a cycloaliphatic hydrocarbon radical which has from 5 to 40 carbon atoms that may contain double bonds, an aromatic hydrocarbon radical having from 6 to 40 carbon atoms, an alkylaryl radical having from 7 to 40 carbon atoms or a radical —C(O)—R⁷ where
   R⁷ is a linear or branched aliphatic hydrocarbon radical which has from 1 to 30 carbon atoms that may contain double bonds, a cycloaliphatic hydrocarbon radical which has from 5 to 40 carbon atoms and may contain double bonds, an aromatic hydrocarbon radical having from 6 to 40 carbon atoms, an alkylaryl radical having from 7 to 40 carbon atoms.

Very particularly preferred imidazolium ions (XVI) are 1-methylimidazolium, 1-ethylimidazolium, 1-(1-butyl)imidazolium, 1-(1-octyl)imidazolium, 1-(1-dodecyl)imidazolium, 1-(1-tetradecyl)imidazolium, 1-(1-hexadecyl)imidazolium, 1,3-dimethylimidazolium, 1-ethyl-3-methylimidazolium, 1-(1-butyl)-3-methylimidazolium, 1-(1-butyl)-3-ethylimidazolium, 1-(1-hexyl)-3-methylimidazolium, 1-(1-hexyl)-3-ethylimidazolium, 1-(1-hexyl)-3-butyl-imidazolium, 1-(1-octyl)-3-methylimidazolium, 1-(1-octyl)-3-ethylimidazolium, 1-(1-octyl)-3-butylimidazolium, 1-(1-dodecyl)-3-methylimidazolium, 1-(1-dodecyl)-3-ethylimidazolium, 1-(1-dodecyl)-3-butylimidazolium, 1-(1-dodecyl)-3-octylimidazolium, 1-(1-tetradecyl)-3-methylimidazolium, 1-(1-tetradecyl)-3-ethylimidazolium, 1-(1-tetradecyl)-3-butylimidazolium, 1-(1-tetradecyl)-3-octylimidazolium, 1-(1-hexadecyl)-3-methylimidazolium, 1-(1-hexadecyl)-3-ethylimidazolium, 1-(1-hexadecyl)-3-butylimidazolium, 1-(1-hexadecyl)-3-octylimidazolium, 1,2-dimethylimidazolium, 1,2,3-trimethylimidazolium, 1-ethyl-2,3-dimethylimidazolium, 1-(1-butyl)-2,3-dimethylimidazolium, 1-(1-hexyl)-2,3-dimethylimidazolium, 1-(1-octyl)-2,3-dimethylimidazolium, 1,4-dimethylimidazolium, 1,3,4-trimethylimidazolium, 1,4-dimethyl-3-ethylimidazolium, 3-butylimidazolium, 1,4-dimethyl-3-octylimidazolium, 1,4,5-trimethylimidazolium, 1,3,4,5-tetramethylimidazolium, 1,4,5-trimethyl-3-ethylimidazolium, 1,4,5-trimethyl-3-butylimidazolium and 1,4,5-trimethyl-3-octylimidazolium.

Further possible cations are ions which are, in particular, formed from the abovementioned cations by dimerisation, trimerisation or polymerisation to give dications, trications or polycations. These also include dications, trications and polycations which have a polymeric backbone, for example a backbone based on siloxanes, polyethers, polyesters, polyamides or polyacrylates, in particular branched and hyperbranched polymers.

Possible ionic liquids also include ones in which the cation [A]⁺ is a pyridinium ion (XVIIa),

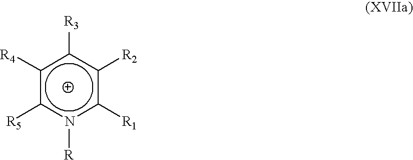

in which
one of the radicals R₁ to R₅ is methyl, ethyl or chlorine and the remaining radicals R₁ to R₅ are each hydrogen;
R₃ is dimethylamino and the remaining radicals R₁, R₂, R₄ and R₅ are each hydrogen;
all radicals R₁ to R₅ are hydrogen;
R₂ is carboxy or carboxamide and the remaining radicals R₁, R₂, R₄ and R₅ are each hydrogen; or
R₁ and R₂ or R₂ and R₃ is 1,4-buta-1,3-dienylene and the remaining radicals R₁, R₂, R₄ and R₅ are each hydrogen; in particular one in which
R₁ to R₅ are each hydrogen; or
one of the radicals R₁ to R₅ is methyl or ethyl and the remaining radicals R₁ to R₅ are each hydrogen.

As very particularly preferred pyridinium ions (XVIIa), mention may be made of 1-methylpyridinium, 1-ethylpyridinium, 1-(1-butyl)pyridinium, 1-(1-hexyl)-pyridinium, 1-(1-octyl)pyridinium, 1-(1-hexyl)pyridinium, 1-(1-octyl)pyridinium, 1-(1-dodecyl)pyridinium, 1-(1-tetradecyl)pyridinium, 1-(1-hexadecyl)pyridinium, 1,2-dimethylpyridinium, 1-ethyl-2-methylpyridinium, 1-(1-butyl)-2-methylpyridinium, 1-(1-hexyl)-2-methylpyridinium, 1-(1-octyl)-2-methylpyridinium, 1-(1-dodecyl)-2-methylpyridinium, 1-(1-tetradecyl)-2-methylpyridinium, 1-(1-hexadecyl)-2-methylpyridinium, 1-methyl-2-ethylpyridinium, 1,2-diethylpyridinium, 1-(1-butyl)-2-ethylpyridinium, 1-(1-hexyl)-2-ethylpyridinium, 1-(1-octyl)-2-ethylpyridinium, 1-(1-dodecyl)-2-ethylpyridinium, 1-(1-tetradecyl)-2-ethylpyridinium, 1-(1-hexadecyl)-2-ethylpyridinium, 1,2-dimethyl-5-ethylpyridinium, 1,5-diethyl-2-methylpyridinium, 1-(1-butyl)-2-methyl-3-ethylpyridinium, 1-(1-hexyl)-2-methyl-3-ethylpyridinium and 1-(1-octyl)-2-methyl-3-ethylpyridinium, 1-(1-dodecyl)-2-methyl-3-ethylpyridinium, 1-(1-tetradecyl)-2-methyl-3-ethylpyridinium and 1-(1-hexadecyl)-2-methyl-3-ethylpyridinium.

Further possible ionic liquids are ones in which the cation [A]⁺ is a pyridazinium ion (XVIIb)

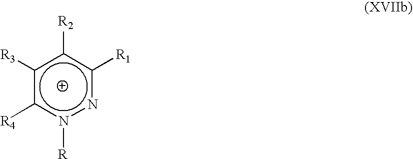

in which
R₁ to R₄ are each hydrogen; or
one of the radicals R₁ to R₄ is methyl or ethyl and the remaining radicals R₁ to R₄ are each hydrogen.

In addition, very particular preference is given to ionic liquids in which the cation [A]⁺ is a pyrimidinium ion (XVIIc)

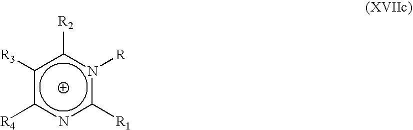

in which
R₁ is hydrogen, methyl or ethyl and R₂ to R₄ are each, independently of one another, hydrogen or methyl; or
R₁ is hydrogen, methyl or ethyl, R₂ and R₄ are each methyl and R₃ is hydrogen.

Further possible ionic liquids are ones in which the cation [A]⁺ is a pyrazinium ion (XVIId)

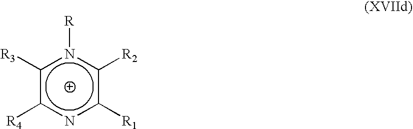

in which
R₁ is hydrogen, methyl or ethyl and R₂ to R₄ are each, independently of one another, hydrogen or methyl;
R₁ is hydrogen, methyl or ethyl, R₂ and R₄ are each methyl and R₃ is hydrogen;
R₁ to R₄ are each methyl; or
R₁ to R₄ are each methyl or hydrogen.

Further possible ionic liquids are ones in which the cation [A]⁺ is a pyrazolium ion (XVIIf), (XVIIg) or (XVIIg′)

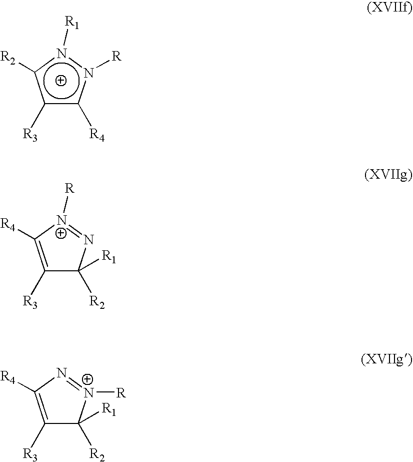

in which
R₁ is hydrogen, methyl or ethyl and R₂ to R₄ are each, independently of one another, hydrogen or methyl.

Further possible ionic liquids are ones in which the cation [A]⁺ is a pyrazolium ion (XVIIh)

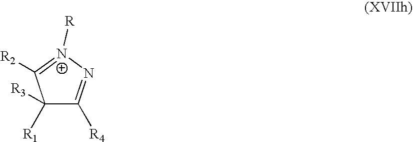

in which
R₁ to R₄ are each, independently of one another, hydrogen or methyl.

Additional possible ionic liquids are ones in which the cation [A]⁺ is a 1-pyrazolinium ion (XVIIi)

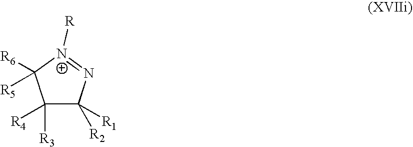

in which
R₁ to R₆ are each, independently of one another, hydrogen or methyl.

Further possible ionic liquids are ones in which the cation [A]⁺ is a 2-pyrazolinium ion (XVIIj)

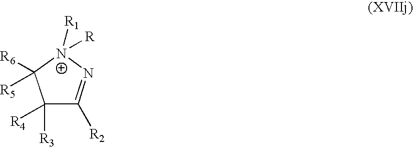

in which
R₁ is hydrogen, methyl, ethyl or phenyl and R₂ to R₆ are each, independently of one another, hydrogen or methyl.

Other possible ionic liquids are ones in which the cation [A]⁺ is a 3-pyrazolinium ion (XVIIk) or (XVIIk′)

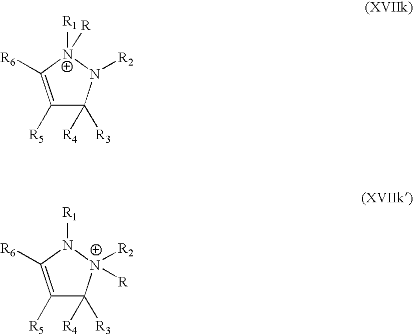

in which
R₁ and R₂ are each, independently of one another, hydrogen, methyl, ethyl or phenyl and R₃ to R₆ are each, independently of one another, hydrogen or methyl.

Additional possible ionic liquids are ones in which the cation [A]⁺ is an imidazolinium ion (XVIII)

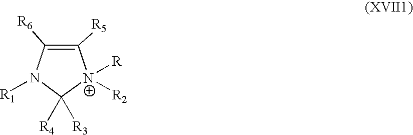

in which
R is H or methyl, R₁ and R₂ are each, independently of one another, hydrogen, methyl or ethyl or a linear saturated or unsaturated acyl radical having from 14 to 22, preferably from 16 to 18, carbon atoms and R₃ to R₆ are each, independently of one another, hydrogen or a linear saturated alkyl radical which has 1-4 carbon atoms and may contain OH groups, preferably methyl or a fatty acid radical; with particular preference being given to R₁ and R₂ being fatty acid acyl radicals and R or R₂ and R₃ being fatty acid acyl radicals. The substances corresponding to formula (XVIIm) are of particular importance. Erroneous formulae (analogous to formulae XVIIm′ or XVIIl) are sometimes also introduced for these in the literature.

Further possible ionic liquids are ones in which the cation [A]⁺ is an imidazolinium ion (XVIIm) or (XVIIm′)

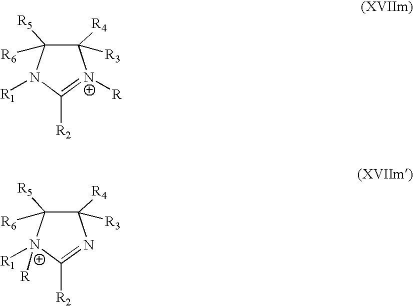

in which
R is H or methyl, R₁ and R₂ are each, independently of one another, hydrogen, methyl or ethyl or a linear saturated or unsaturated acyl radical having from 14 to 22, preferably from 16 to 18, carbon atoms and R₃ to R₆ are each, independently of one another, hydrogen or a linear saturated alkyl radical which has 1-4 carbon atoms and may contain OH groups, preferably methyl or a fatty acid radical; with particular preference being given to R₁ and R₂ being fatty acid acyl radicals and R or R₂ and R₃ being fatty acid acyl radicals. The substances corresponding to formula (XIIIm) are of particular importance. Erroneous formulae (analogous to formulae XIIIm′ or XIIIl) are sometimes also introduced for these in the literature.

Further possible ionic liquids are ones in which the cation [A]⁺ is an imidazolinium ion (XVIIn) or (XVIIn′)

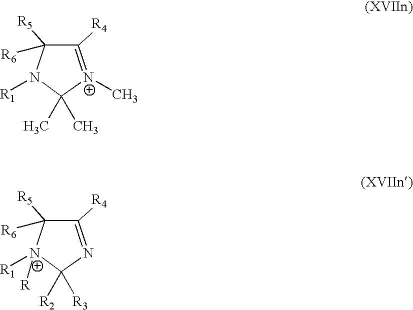

in which
R₁ to R₃ are each, independently of one another, hydrogen, methyl or ethyl and R₄ to R₆ are each, independently of one another, hydrogen or methyl.

Additional possible ionic liquids are ones in which the cation [A]⁺ is a thiazolium ion (XVIIo) or (XVIIo′) or an oxazolium ion (XVIIp)

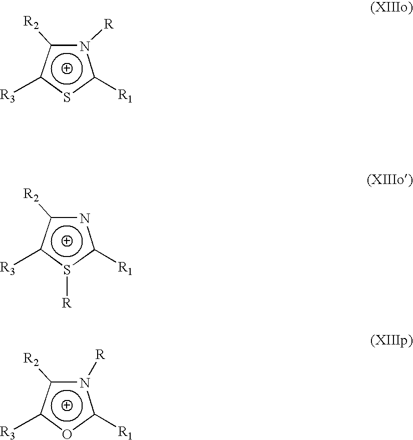

in which
R₁ is hydrogen, methyl, ethyl or phenyl and R₂ and R₃ are each, independently of one another, hydrogen or methyl.

Other possible ionic liquids are ones in which the cation [A]⁺ is a 1,2,4-triazolium ion (XVIIq), (XVIIq′) or (XVIIq″)

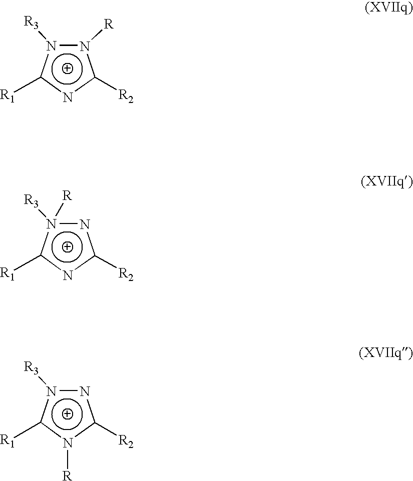

in which
R₁ and R₂ are each, independently of one another, hydrogen, methyl, ethyl or phenyl and R₃ is hydrogen, methyl or phenyl.

Further possible ionic liquids are ones in which the cation [A]⁺ is a 1,2,3-triazolium ion (XVIIr), (XVIIr′) or (XVIIr″)

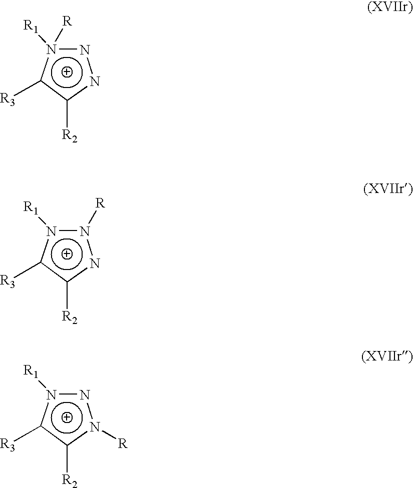

in which
R₁ is hydrogen, methyl or ethyl and R₂ and R₃ are each, independently of one another, hydrogen or methyl, or R₂ and R₃ together are 1,4-buta-1,3-dienylene.

Additional possible ionic liquids are ones in which the cation [A]⁺ is a pyrrolidinium ion (XVIIs)

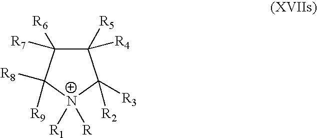

in which
R₁ is hydrogen, methyl, ethyl or phenyl and R₂ to R₉ are each, independently of one another, hydrogen or methyl.

Additional possible ionic liquids are ones in which the cation [A]⁺ is an imidazolidinium ion (XVIIt)

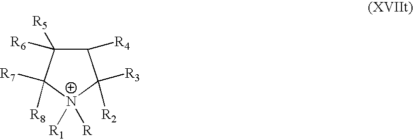

in which
R₁ and R₄ are each, independently of one another, hydrogen, methyl, ethyl or phenyl and R₂ and R₃ and also R₅ to R₈ are each, independently of one another, hydrogen or methyl.

Other possible ionic liquids are ones in which the cation [A]⁺ is an ammonium ion (IV)

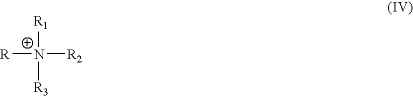

in which
R₁ to R₃ are each, independently of one another, C₁-C₁₈-alkyl; or
R₁ to R₃ are each, independently of one another, hydrogen or C₁-C₁₈-alkyl and R₄ is 2-hydroxyethyl; or
R₁ and R₂ together are 1,5-pentylene or 3-oxa-1,5-pentylene and R₃ is C₁-C₁₈-alkyl, 2-hydroxyethyl or 2-cyanoethyl.

As particularly preferred ammonium ions (IV), mention may also be made of methyltri(1-butyl)ammonium, 2-hydroxyethylammonium, bis(2-hydroxyethyl)dimethylammonium, N,N-dimethylpiperidinium and N,N-dimethylmorpholinium. Additional possible ionic liquids are ones in which the cation [A]⁺ is a guanidinium ion (IVv)

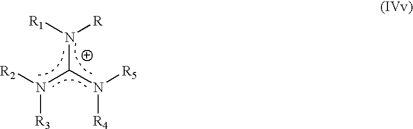

in which
R₁ to R₅ are each methyl;
R₁ to R₅ are each, independently of one another, C₁-C₁₈-alkyl; or
R₁ or R₅ are each, independently of one another, hydrogen or C₁-C₁₈-alkyl or 2-hydroxyethyl.

As a very particularly preferred guanidinium ion (IVv), mention may be made of N,N,N′,N′,N″,N″-hexamethylguanidinium.

Other possible ionic liquids are ones in which the cation [A]⁺ is a derivative of an ethanolamine, e.g. a cholinium ion (XVIIw), or a diethanolamine (XVIIw′) or a triethanolamine (XVIIw″)

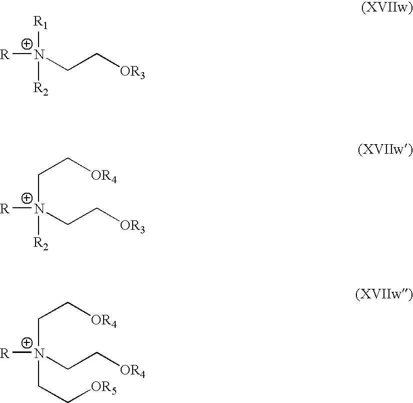

in which
R₁ and R₂ are each, independently of one another, methyl, ethyl, 1-butyl or 1-octyl and R₃ is hydrogen, methyl, ethyl, acetyl, —SO₂OH or —PO(OH)₂;
R₁ is methyl, ethyl, 1-butyl or 1-octyl, R₂ is a —CH₂—CH₂—OR₄— group and R₃ and R₄ are each, independently of one another, hydrogen, methyl, ethyl, acetyl, —SO₂OH or —PO(OH)₂; or
R₁ is a —CH₂—CH₂—OR₄— group, R₂ is a —CH₂—CH₂—OR₅— group and R₃ to R₅ are each, independently of one another, hydrogen, methyl, ethyl, acetyl, —SO₂OH or —PO(OH)₂;
R₁ is methyl, ethyl, 1-butyl, 1-octyl, acetyl, —SO₂OH, or —PO(OH)₂ and R₃ to R₅ are each, independently of one another, hydrogen, methyl, ethyl, acetyl, —SO₂OH, —PO(OH)₂ or —(CₙH₂ₙO)ₘR₁ where n=1 to 5 and m=1 to 100.
   Preference is also given to compounds in which R, R₁ and R₂ are alkyl groups having from 1 to 4 carbon atoms, particularly preferably a methyl group, and R₃ and/or R₄ are saturated or unsaturated fatty acid or acyl radicals having from 8 to 22 carbon atoms, preferably from 12 to 18 carbon atoms. It is also possible for mixtures of the acyl or fatty acid esters to be present (in particular, for example, in naturally occurring ratios).
   In the case of formula (XVIIw″), very particular preference is given to R, R₁, R₂ each being an alkyl radical having from 1 to 4 carbon atoms, in particular methyl groups, and R₃ being a fatty acid radical and R₄ and R₅ each being a fatty acid radical or hydrogen.

Further possible ionic liquids are ones in which the cation [A]⁺ is a phosphonium ion (VI) in which
R₁ to R₃ are each, independently of one another, C₁-C₁₈-alkyl, in particular butyl, isobutyl, 1-hexyl or 1-octyl.

Among the abovementioned cations, preference is given to the pyridinium ions (XVIIa), imidazolium ions (XVI) and ammonium ions (IV), in particular 1-methylpyridinium, 1-ethylpyridinium, 1-(1-butyl)pyridinium, 1-(1-hexyl)-pyridinium, 1-(1-octyl)pyridinium, 1-(1-hexyl)pyridinium, 1-(1-octyl)pyridinium, 1-(1-dodecyl)pyridinium, 1-(1-tetradecyl)pyridinium, 1-(1-hexadecyl)pyridinium, 1,2-dimethylpyridinium, 1-ethyl-2-methylpyridinium, 1-(1-butyl)-2-methylpyridinium, 1-(1-hexyl)-2-methylpyridinium, 1-(1-octyl)-2-methylpyridinium, 1-(1-dodecyl)-2-methylpyridinium, 1-(1-tetradecyl)-2-methylpyridinium, 1-(1-hexadecyl)-2-methylpyridinium, 1-methyl-2-ethylpyridinium, 1,2-diethylpyridinium, 1-(1-butyl)-2-ethylpyridinium, 1-(1-hexyl)-2-ethylpyridinium, 1-(1-octyl)-2-ethylpyridinium, 1-(1-dodecyl)-2-ethylpyridinium, 1-(1-tetradecyl)-2-ethylpyridinium, 1-(1-hexadecyl)-2-ethylpyridinium, 1,2-dimethyl-5-ethylpyridinium, 1,5-diethyl-2-methylpyridinium, 1-(1-butyl)-2-methyl-3-ethylpyridinium, 1-(1-hexyl)-2-methyl-3-ethylpyridinium, 1-(1-octyl)-2-methyl-3-ethylpyridinium, 1-(1-dodecyl)-2-methyl-3-ethylpyridinium, 1-(1-tetradecyl)-2-methyl-3-ethylpyridinium, 1-(1-hexadecyl)-2-methyl-3-ethylpyridinium, 1-methylimidazolium, 1-ethylimidazolium, 1-(1-butyl)imidazolium, 1-(1-octyl)-imidazolium, 1-(1-dodecyl)imidazolium, 1-(1-tetradecyl)-imidazolium, 1-(1-hexadecyl)imidazolium, 1,3-dimethyl-imidazolium, 1-ethyl-3-methylimidazolium, 1-(1-butyl)-3-methylimidazolium, 1-(1-hexyl)-3-methylimidazolium, 1-(1-octyl)-3-methylimidazolium, 1-(1-dodecyl)-3-methylimidazolium, 1-(1-tetradecyl)-3-methylimidazolium, 1-(1-hexadecyl)-3-methylimidazolium, 1,2-dimethylimidazolium, 1,2,3-trimethylimidazolium, 1-ethyl-2,3-dimethylimidazolium, 1-(1-butyl)-2,3-dimethylimidazolium, 1-(1-hexyl)-2,3-dimethylimidazolium and 1-(1-octyl)-2,3-dimethylimidazolium, 1,4-dimethylimidazolium, 1,3,4-trimethylimidazolium, 1,4-dimethyl-3-ethylimidazolium, 3-butylimidazolium, 1,4-dimethyl-3-octylimidazolium, 1,4,5-trimethylimidazolium, 1,3,4,5-tetramethylimidazolium, 1,4,5-trimethyl-3-ethylimidazolium, 1,4,5-trimethyl-3-butylimidazolium, 1,4,5-trimethyl-3-octylimidazolium and 2-hydroxyethylammonium.

The metal cations [M¹]⁺, [M²]⁺, [M³]⁺, [M⁴]²⁺ and [M⁵]³⁺ in the formulae (IIIa) to (IIIj) are generally metal cations of groups 1, 2, 6, 7, 8, 9, 10, 11, 12 and 13 of the Periodic Table. Examples of suitable metal cations are Li⁺, Na⁺, K⁺, Cs⁺, Mg⁺, Ca²⁺, Ba²⁺, Cr³⁺, Fe²⁺, Fe³⁺, Co²⁺, Ni²⁺, Cu²⁺, Ag⁺, Zn²⁺ and Al³⁺.

The ionic liquids used according to the invention comprise at least one of the abovementioned cations combined with in each case at least one anion. Possible anions are principally all anions which in combination with the cation lead to an ionic liquid.

The anion [Y]ⁿ⁻ of the ionic liquid is, for example, selected from:
the group of halides and halogen-containing compounds of the formulae: F⁻ Cl⁻, Br⁻, I⁻, BF₄⁻, PF₆⁻, AlCl₄⁻, Al₂Cl₇⁻, Al₃Cl₁₀⁻, AlBr₄⁻, FeCl₄⁻, BCl₄⁻, SbF₆⁻, AsF₆⁻, ZnCl₃⁻, SnCl₃⁻, CuCl₂⁻, CF₃SO₃⁻, (CF₃SO₃)₂N⁻, CF₃CO₂⁻, CCl₃CO₂⁻, CN⁻, SCN⁻, OCN⁻, NO₂⁻, NO₃⁻, N(CN)⁻;
the group of sulphates, sulphites and sulphonates of the general formulae: SO₄²⁻, HSO₄⁻, SO^{2″}, HSO₃⁻, R^{a}OSO₃⁻, R^{a}SO₃⁻;
the group of phosphates of the general formulae: PO₄³⁻, HPO₄²⁻, H₂PO⁴⁻, R^{a}PO₄²⁻, HR^{a}PO₄, R^{a}R^{b}PO₄⁻;
the group of the phosphonates and phosphinates of the general formulae: R^{a}HPO₃⁻R^{a}R^{b}PO₂⁻R^{a}R^{b}PO₃⁻;
the group of phosphites of the general formulae: PO₃³⁻HPO₃²⁻, H₂PO₃⁻, R^{a}PO₃²⁻, R^{a}HPO₃⁻, R^{a}R^{b}PO₃⁻;
the group of phosphonites and phosphinites of the general formulae: R^{a}R^{b}PO₂⁻, R^{a}HPO₂⁻, R^{a}R^{b}PO⁻, R^{a}HPO⁻
the group of carboxylates of the general formula: R^{a}COO⁻;
the group of borates of the general formulae: BO₃³⁻, HBO₃²⁻, H₂BO₃⁻, R^{a}R^{b}BO₃⁻, R^{a}HBO₃⁻, R^{a}BO₃²⁻, B(OR^{a})(OR^{b})(OR^{c})(OR^{d})⁻, B (HSO₄)⁻, B(R^{a}SO₄)⁻;
the group of boronates of the general formulae: R^{a}BO₂²⁻, R^{a}R^{b}BO⁻;
the group of carbonates and carbonic esters of the general formulae: HCO₃⁻, CO₃²⁻, R^{a}CO₃⁻;
the group of silicates and silicic esters of the general formulae: SiO₄⁴⁻, HSiO₄³⁻, H₂SiO₄²⁻, H₃SiO₄⁻, R^{a}SiO₄³⁻, R^{a}R^{b}SiO₄²⁻, R^{a}R^{b}R^{c}SiO₄⁻, HR^{a}SiO₄²⁻, H₂R^{a}SiO₄⁻, HR^{a}R^{b}SiO₄⁻;
the group of alkylsilane and arylsilane salts of the general formulae: R^{a}SiO₃³⁻, R^{a}R^{b}SiO₂²⁻, R^{a}R^{b}R^{c}SiO⁻, R^{a}R^{b}R^{c}SiO₃⁻, R^{a}R^{b}R^{c}SiO₂⁻, R^{a}R^{b}SiO₃²⁻;
the group of carboximides, bis(sulphonyl)imides and sulphonylimides of the general formulae:

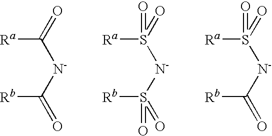

the group of methides of the general formula:

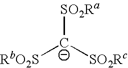

the group of alkoxides and aryloxides of the general formula: R^{a}O⁻;
the group of halometalates of the general formula [MᵣHalₜ]^{s-}, where M is a metal and Hal is fluorine, chlorine, bromine or iodine, r and t are positive integers and indicate the stoichiometry of the complex and s is a positive integer and indicates the charge on the complex;
the group of sulphides, hydrogensulphides, polysulphides, hydrogenpolysulphides and thiolates of the general formulae:
   S²⁻, HS⁻, [Sᵥ]²⁻, [HSᵥ]⁻, [R^{a}S]⁻, where v is a positive integer from 2 to 10;
the group of complex metal ions such as Fe(CN)₆³⁻, Fe(CN)₆⁴⁻, MnO₄⁻, Fe(CO)₄⁻.

Here, R^{a}, R^{b}, R^{c} and R^{d} are each, independently of one another,
hydrogen;
C₁-C₃₀-alkyl and aryl-, heteroaryl-, cycloalkyl-, halogen-, hydroxy-, amino-, carboxy-, formyl-, —O—, —CO—, —CO—O— or —CO—N<substituted derivatives thereof, for example, methyl, ethyl, 1-propyl, 2-propyl, 1-butyl, 2-butyl, 2-methyl-1-propyl (isobutyl), 2-methyl-2-propyl (tert-butyl), 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, heptyl, octyl, nonyl, decyl, undecyl, dodecyl, tridecyl, tetradecyl, pentadecyl, hexadecyl, heptadecyl, octadecyl, nonadecyl, icosyl, henicosyl, docosyl, tricosyl, tetracosyl, pentacosyl, hexacosyl, heptacosyl, octacosyl, nonacosyl, triacontyl, phenylmethyl (benzyl), diphenylmethyl, triphenylmethyl, 2-phenylethyl, 3-phenylpropyl, cyclopentylmethyl, 2-cyclopentylethyl, 3-cyclopentylpropyl, cyclohexylmethyl, 2-cyclohexylethyl, 3-cyclohexylpropyl, methoxy, ethoxy, formyl, acetyl or C_{q}F_{2(q-a)+(1-b)}H_{2a+b} where q<30, 0≦a≦q and b=0 or 1 (for example CF₃, C₂F₅, CH₂CH₂—C_{(q-2)}F_{2(q-2)+1}, C₆F₁₃, C₈F₁₇, C₁₀F₂₁, C₁₂F₂₅);
C₃-C₁₂-cycloalkyl and aryl-, heteroaryl-, cycloalkyl-, halogen-, hydroxy-, amino-, carboxy-, formyl-, —O—, —CO— or —CO—O-substituted derivatives thereof, for example cyclopentyl, 2-methyl-1-cyclopentyl, 3-methyl-1-cyclopentyl, cyclohexyl, 2-methyl-1-cyclohexyl, 3-methyl-1-cyclohexyl, 4-methyl-1-cyclohexyl or C_{q}F_{2(q-a)-(1-b)}H_{2a-b} where q≦30, 0≦a≦q and b=0 or 1;
C₂-C₃₀-alkenyl and aryl-, heteroaryl-, cycloalkyl-, halogen-, hydroxy-, amino-, carboxy-, formyl-, —O—, —CO— or —CO—O-substituted derivatives thereof, for example 2-propenyl, 3-butenyl, cis-2-butenyl, trans-2-butenyl or C_{q}F_{2(q-a)-(1-b)}H_{2a-b} where q≦30, 0≦a≦q and b=0 or 1;
C₃-C₁₂-cycloalkenyl and aryl-, heteroaryl-, cycloalkyl-, halogen-, hydroxy-, amino-, carboxy-, formyl-, —O—, —CO— or —CO—O-substituted derivatives thereof, for example 3-cyclopentenyl, 2-cyclohexenyl, 3-cyclohexenyl, 2,5-cyclohexadienyl or C_{q}F_{2(q-a)-3(1-b)}H_{2a-3b} where q≦30, 0≦a≦q and b=0 or 1;
aryl or heteroaryl having from 2 to 30 carbon atoms and alkyl-, aryl-, heteroaryl-, cycloalkyl-, halogen-, hydroxy-, amino-, carboxy-, formyl-, —O—, —CO— or —CO—O-substituted derivatives thereof, for example phenyl, 2-methylphenyl (2-tolyl), 3-methylphenyl (3-tolyl), 4-methylphenyl, 2-ethylphenyl, 3-ethylphenyl, 4-ethylphenyl, 2,3-dimethylphenyl, 2,4-dimethylphenyl, 2,5-dimethylphenyl, 2,6-dimethylphenyl, 3,4-dimethylphenyl, 3,5-dimethylphenyl, 4-phenylphenyl, 1-naphthyl, 2-naphthyl, 1-pyrrolyl, 2-pyrrolyl, 3-pyrrolyl, 2-pyridinyl, 3-pyridinyl, 4-pyridinyl or C₆F₍₅₋ₐ₎Hₐ where 0≦a≦5; or
two radicals form an unsaturated, saturated or aromatic ring which may be substituted by functional groups, aryl, alkyl, aryloxy, alkyloxy, halogen, heteroatoms and/or heterocycles and may be interrupted by one or more oxygen and/or sulphur atoms and/or one or more substituted or unsubstituted imino groups.

Examples of possible anions are chloride; bromide; iodide; thiocyanate; hexafluorophosphate; trifluoromethanesulphonate; methanesulphonate; formate; acetate; glycolate; lactate; oxalate; citrate; malate; maleate; tartrate; mandelate; nitrate; nitrite; trifluoroacetate; sulphate; hydrogensulphate; methylsulphate; ethyl sulphate; 1-propylsulphate; 1-butylsulphate; 1-hexylsulphate; 1-octylsulphate; phosphate; dihydrogenphosphate; hydrogenphosphate; C₁-C₄-dialkylphosphates; propionate; tetrachloroaluminate; Al₂Cl₇⁻; chlorozincate; chloroferrate; bis(trifluoromethylsulphonyl)imide; bis(pentafluoroethylsulphonyl)imide; bis(methylsulphonyl)imide; bis(p-toluenesulphonyl)imide; tris(trifluoromethylsulphonyl)methide; bis(pentafluoroethylsulphonyl)methide; p-toluenesulphonate; tetracarbonylcobaltate; dimethylene glycol monomethyl ether sulphate; oleate; stearate; acrylate; methacrylate; maleate; hydrogencitrate; vinylphosphonate; bis(pentafluoroethyl)phosphinate; borates such as bis[salicylato(2-)]borate, bis[oxalato(2-)]borate, bis[1,2-benzenediolato(2-)-O,O′]borate, tetracyanoborate, tetrafluoroborate; dicyanamide; tris(pentafluoroethyl)-trifluorophosphate; tris(heptafluoropropyl)trifluorophosphate, cyclic arylphosphates such as catecholphosphate (C₆H₄O₂)P(O)O⁻ and chlorocobaltate.

Preferred anions are selected from the group, without making any claim as to completeness, consisting of halides, bis(perfluoroalkylsulphonyl)amides and bis(perfluoroalkylsulphonyl)imides, e.g. bis(trifluoromethylylsulphonyl)imide, alkyltosylates and aryltosylates, perfluoroalkyltosylates, nitrate, sulphate, hydrogensulphate, alkylsulphates and arylsulphates, polyether sulphates and polyether sulphonates, perfluoroalkylsulphates, sulphonate, alkylsulphonates and arylsulphonates, perfluorinated alkylsulphonates and arylsulphonates, alkylcarboxylates and arylcarboxylates, perfluoroalkylcarboxylates, perchlorate, tetrachloroaluminate, saccharinate, also dicyanamide, thiocyanate, isothiocyanate, tetraphenylborate, tetrakis(pentafluorophenyl)borate, tetrafluoroborate, hexafluorophosphate, polyetherphosphates and phosphate.

Very particularly preferred anions are:

Chloride, bromide, hydrogensulphate, tetrachloroaluminate, thiocyanate, methylsulphate, ethyl sulphate, methanesulphonate, formate, acetate, glycolate, lactate, dimethylphosphate, diethylphosphate, p-toluenesulphonate, tetrafluoroborate and hexafluorophosphate.

In a further preferred embodiment of the invention, use is made of ionic liquids or mixtures thereof which contain a combination of a 1,3-dialkylimidazolium, 1,2,3-trialkylimidazolium, 1,3-dialkylimidazolinium or 1,2,3-trialkylimidazolinium cation with an anion selected from the group consisting of halides, bis(trifluoromethylylsulphonyl)imide, perfluoroalkyltosylates, alkylsulphates and alkylsulphonates, perfluorinated alkylsulphonates and alkylsulphates, perfluoroalkylcarboxylates, perchlorate, dicyanamide, thiocyanate, isothiocyanate, tetraphenylborate, tetrakis(pentafluorophenyl)borate, tetrafluoroborate, hexafluorophosphate, acetate, glycolate, lactate.

It is also possible to use simple, commercially available, acyclic quaternary ammonium salts such as TEGO® IL T16ES, TEGO® IL K5MS, TEGO® IL DS or TEGO® IL 2MS (products of Evonik Goldschmidt GmbH).

Ionic liquids which are particularly preferred for the purposes of the present disclosure are: 1-Butyl-3-methylimidazolium 2-(2-methoxyethoxy)ethylsulphate, 1-butyl-3-methylimidazolium acetate, 1-ethyl-3-methylimidazolium acetate, tetrabutylammonium benzoate, trihexyltetradecylphosphonium bis(2,4,4-trimethylpentyl)-phosphinate, 1-ethyl-3-methylimidazolium bis(pentafluoroethylsulphonyl)imide, 1-butyl-1-methylpyrrolidinium bis(trifluoromethylsulphonyl)imide, 1-butyl-3-methylimidazolium bis(trifluoromethylsulphonyl)imide, 1-butyl-3-methylpyridinium bis(trifluoromethylsulphonyl)imide, 1,2-dimethyl-3-propylimidazolium bis(trifluoromethylsulphonyl)-imide, 1-ethyl-3-methylimidazolium bis(trifluoromethylsulphonyl)imide, 3-methyl-1-propylpyridinium bis(trifluoromethylsulphonyl)imide, methyltrioctylammonium bis(trifluoromethylsulphonyl)imide, tetrabutylammonium bis(trifluoromethylsulphonyl)imide, trihexyltetradecylphosphonium bis(trifluoromethylsulphonyl)imide, 1-butyl-1-methylpyrrolidinium bromide, 1-butylpyridinium bromide, 1-ethyl-3-methylimidazolium bromide, 4-methyl-N-butylpyridinium bromide, tetrabutylammonium bromide, tetrabutylphosphonium bromide, tetraheptylammonium bromide, tetrahexylammonium bromide, tetraoctylammonium bromide, tetraoctylphosphonium bromide, tetrapentylammonium bromide, tributylhexadecylphosphonium bromide, 1-allyl-3-methylimidazolium chloride, 1-benzyl-3-methylimidazolium chloride, 1-butyl-1-methylpyrrolidinium chloride, 1-butyl-2,3-dimethylimidazolium chloride, 1-butyl-3-methylimidazolium chloride, 1-butyl-4-methylpyridinium chloride, 1-ethyl-2,3-dimethylimidazolium chloride, 1-ethyl-3-methylimidazolium chloride, 1-hexyl-3-methylimidazolium chloride, 1-methyl-3-octylimidazolium chloride, methylimidazolium chloride, tetrabutylammonium chloride, tetrabutylphosphonium chloride, tetraheptylammonium chloride, tetraoctylammonium chloride, trihexyltetradecylphosphonium chloride, butylammonium α-cyano-4-hydrocinnamate, diethylammonium α-cyano-4-hydrocinnamate, trihexyltetradecylphosphonium decanoate, 1-butyl-1-methylpyrrolidinium dicyanamide, 1-butyl-3-methylimidazolium dicyanamide, 1-ethyl-3-methylimidazolium dicyanamide, trihexyltetradecylphosphonium dicyanamide, 1-ethyl-2,3-dimethylimidazolium ethylsulphate, 1-ethyl-3-methylimidazolium ethylsulphate, 1-benzyl-3-methylimidazolium hexafluorophosphate, 1-butyl-2,3-dimethylimidazolium hexafluorophosphate, tridecafluorooctyl)imidazolium hexafluorophosphate, 1-butyl-3-methylimidazolium hexafluorophosphate, 1-ethyl-3-methylimidazolium hexafluorophosphate, 1-hexyl-3-methylimidazolium hexafluorophosphate, 1-methyl-3-(3,3 . . . -tridecafluorooctyl)imidazolium hexafluorophosphate, 1-butyl-4-methylpyridinium hexafluorophosphate, 1-methyl-3-octylimidazolium hexafluorophosphate, trihexyltetradecylphosphonium hexafluorophosphate, 1-butyl-3-methylimidazolium hydrogensulphate, 1-ethyl-3-methylimidazolium hydrogensulphate, methylimidazolium hydrogensulphate, 1-dodecyl-3-methylimidazolium hydrogensulphate, 1-dodecyl-3-methylimidazolium iodide, tetrahexylammonium iodide, 1-butyl-3-methylimidazolium methanesulphonate, 1-ethyl-3-methylimidazolium methanesulphonate, tetrabutylammonium methanesulphonate, tetrabutylphosphonium methanesulphonate, 1-butyl-3-methylimidazolium methylsulphate, 1,3-dimethylimidazolium methylsulphate, methyltributylammonium methylsulphate, 1-ethyl-3-methylimidazolium methylsulphate, 1,2,3-trimethylimidazolium methylsulphate, 1-butyl-3-methylimidazolium nitrate, 1-ethyl-3-methylimidazolium nitrate, tetrabutylammonium nonafluorobutanesulphonate, tetrabutylammonium heptadecafluorooctanesulphonate, 1-butyl-3-methylimidazolium octylsulphate, 4-(3-butyl-1-imidazolio)butane-1-sulphonate, 3-(triphenylphosphonio)propane-1-sulphonate, 1-butyl-3-methylimidazolium tetrachloroaluminate, 1-ethyl-3-methylimidazolium tetrachloroaluminate, 1-benzyl-3-methylimidazolium tetrafluoroborate, 1-butyl-2,3-dimethylimidazolium tetrafluoroborate, 1-butyl-3-methylimidazolium tetrafluoroborate, 1-ethyl-3-methylimidazolium tetrafluoroborate, 1-hexyl-3-methylimidazolium tetrafluoroborate, 1-methyl-3-octylimidazolium tetrafluoroborate, 1-butyl-1-methylpyrrolidinium tetrafluoroborate, 1-butyl-4-methylpyridinium tetrafluoroborate, tetrabutylammonium tetrafluoroborate, tetrahexylammonium tetrafluoroborate, tetrabutylphosphonium tetrafluoroborate, trihexyltetradecylphosphonium tetrafluoroborate, 1-butyl-3-methylimidazolium thiocyanate, 1-ethyl-3-methylimidazolium thiocyanate, tetrapentylammonium thiocyanate, trioctylmethylammonium thiosalicylate, 1-butyl-3-methylimidazolium tosylate, 1-ethyl-3-methylimidazolium tosylate, tetrabutylphosphonium tosylate, triisobutylmethylphosphonium tosylate, 3-(triphenylphosphonio)propane-1-sulphonic acid tosylate, tetraethylammonium trifluoroacetate, 4-(3-butyl-1-imidazolio)butane-1-sulphonic acid trifluoromethanesulphonate, 1-butyl-3-methylimidazolium trifluoromethanesulphonate, 1-ethyl-2,3-dimethylimidazolium trifluoromethanesulphonate, 1-ethyl-3-methylimidazolium trifluoromethanesulphonate, 1-hexyl-3-methylimidazolium trifluoromethanesulphonate, 1-methyl-3-octylimidazolium trifluoromethanesulphonate, tetraethylammonium trifluoromethanesulphonate, 1,2,3-trimethylimidazolium trifluoromethanesulphonate, 1-hydroxyethyl-3-methylimidazolium 2-(2-methoxyethoxy)ethylsulphate, 1-hydroxyethyl-3-methylimidazolium acetate, 1-hydroxyethyl-3-methylimidazolium trifluoroacetate, 1-hydroxyethyl-3-methylimidazolium bis(trifluoromethylsulphonyl)imide, 1-hydroxyethyl-3-methylimidazolium bromide, 1-hydroxyethyl-3-methylimidazolium chloride, 1-hydroxyethyl-3-methylimidazolium decanoate, 1-hydroxyethyl-3-methylimidazolium dicyanamide, 1-hydroxyethyl-3-methylimidazolium hexafluorophosphate, 1-hydroxyethyl-3-methylimidazolium hydrogensulphate, 1-hydroxyethyl-3-methylimidazolium iodide, 1-hydroxyethyl-3-methylimidazolium methanesulphonate, 1-hydroxyethyl-3-methylimidazolium methylsulphate, 1-hydroxyethyl-3-methylimidazolium ethylsulphate, 1-hydroxyethyl-3-methylimidazolium nitrate, 1-hydroxyethyl-3-methylimidazolium phosphate, 1-hydroxyethyl-3-methylimidazolium octylsulphate, 1-hydroxyethyl-3-methylimidazolium tetrachloroaluminate, 1-hydroxyethyl-3-methylimidazolium tetrafluoroborate, 1-hydroxyethyl-3-methylimidazolium thiocyanate, 1-hydroxyethyl-3-methylimidazolium salicylate, 1-hydroxyethyl-3-methylimidazolium thiosalicylate, 1-hydroxyethyl-3-methylimidazolium tosylate, 1-hydroxyethyl-3-methylimidazolium trifluoromethanesulphonate, 1-hydroxyethyl-3-methylimidazolium lactate, 1-hydroxyethyl-3-methylimidazolium glycolate, 1-hydroxyethyl-3-methylimidazolium citrate, 1-hydroxyethyl-3-methylimidazolium oxalate, 1-hydroxyethyl-3-methylimidazolium tartrate, bis(hydroxyethyl)dimethylammonium acetate, bis(hydroxyethyl)dimethylammonium trifluoroacetate, bis(hydroxyethyl) dimethylammonium bis(trifluoromethylsulphonyl)imide, bis(hydroxyethyl)dimethylammonium bromide, bis(hydroxyethyl)dimethylammonium chloride, bis(hydroxyethyl)dimethylammonium decanoate, bis(hydroxyethyl)dimethylammonium dicyanamide, bis(hydroxyethyl)dimethylammonium hexafluorophosphate, bis(hydroxyethyl)dimethylammonium hydrogensulphate, bis(hydroxyethyl)dimethylammonium iodide, bis(hydroxyethyl)dimethylammonium methanesulphonate, bis(hydroxyethyl)dimethylammonium methylsulphate, bis(hydroxyethyl)dimethylammonium ethylsulphate, bis(hydroxyethyl)dimethylammonium nitrate, bis(hydroxyethyl)dimethylammonium phosphate, bis(hydroxyethyl)dimethylammonium octylsulphate, bis(hydroxyethyl)dimethylammonium tetrachloroaluminate, bis(hydroxyethyl)dimethylammonium tetrafluoroborate, bis(hydroxyethyl)dimethylammonium thiocyanate, bis(hydroxylethyl)dimethylammonium salicylate, bis(hydroxylethyl)dimethylammonium thiosalicylate, bis(hydroxylethyl)dimethylammonium tosylate, bis(hydroxyethyl)dimethylammonium trifluoromethanesulphonate, bis(hydroxyethyl)dimethylammonium lactate, bis(hydroxyethyl)dimethylammonium glycolate, bis(hydroxyethyl)dimethylammonium citrate, bis(hydroxyethyl)dimethylammonium oxalate, bis(hydroxyethyl)dimethylammonium tartrate.

In general, significant reductions in the surface resistances are obtained when using mixtures having a mixing ratio of ionic liquid to alkali metal salt in the range from 1:10 to 10:1. In such a mixture, the alkali metal salt should be present in a proportion of from 0.1 to 75% by weight, preferably a proportion of from 0.5 to 50% by weight, particularly preferably a proportion of from 5 to 30% by weight.

The salts which are concomitantly used according to the invention in the artificial stone for flat structures are the simple or complex compounds which are usually used in this field, for example and in particular alkali metal salts of the anions: bis(perfluoroalkylsulphonyl)amide or bis(perfluoroalkylsulphonyl)imide, e.g. bis(trifluoromethylsulphonyl)imide, alkyltosylates and aryltosylates, perfluoroalkyltosylates, nitrate, sulphate, hydrogensulphate, alkylsulphates and arylsulphates, polyethersulphates and polyethersulphonates, perfluoroalkylsulphates, sulphonate, alkylsulphonates and arylsulphonates, perfluorinated alkylsulphonates and arylsulphonates, alkylcarboxylate and arylcarboxylates, perfluoroalkylcarboxylates, perchlorate, tetrachloroaluminate, saccharinate, preferably anions of the compounds thiocyanate, isothiocyanate, dicyanamide, tetraphenylborate, tetrakis(pentafluorophenyl)borate, tetrafluoroborate, hexafluorophosphate, phosphate and polyetherphosphates.

Preferred mixtures are, in particular, those containing NaSCN or NaN(CN)₂ and KPF₆ as alkali metal salt and an imidazolinium or imidazolium salt, preferably 1-ethyl-3-methylimidazolium ethylsulphate, 1-ethyl-3-methylimidazolium hexafluorophosphate and as ionic liquid 1-ethyl-3-methylimidazolium ethylsulphate/NaN(CN)₂ or 1-ethyl-3-methylimidazolium hexafluorophosphate/NaN(CN)₂.

The present invention provides for variants in which the constituent matrix of the artificial stone claimed for flat structures comprises not more than 25% by weight of at least one polymer matrix containing a polyurethane, epoxy resin, polyester resin, acrylate, methacrylate and/or vinyl ester and a reactive silane, e.g. methacrylsilane. In contrast to thick floor coatings, the present invention provides that the constituent matrix of the artificial stone comprises at least 60% by weight of abraded solid, e.g. marble, quartz or granite, but, for example, also glass or porcelain or solid plastics. In addition, fillers and/or pigments which preferably have conductive properties are present. Possibilities are, in particular, carbon fibres such as carbon fibres based on polyacrylonitrile (PAN), pitch and Reyon®, graphite, carbon black, metal oxides and metal alloy oxides. Fillers and pigments which are coated with components which give them conductive properties are likewise suitable. In this case, too, graphites, carbon blacks and metal oxide or metal alloy oxides are particularly suitable.

The fully cured artificial stone having the abraded solid in the polymer matrix is characterized by being able, if appropriate, to be ground and/or polished using methods known to those skilled in the art in order to achieve an aesthetically desirable surface structure without the antistatic properties being adversely affected.

The (raw) artificial stone which needs to be treated antistatically is characterized in that its specific resistance is 10¹¹ ohm and above and is therefore significantly above the resistances of thick floor coatings made of polymer.

If the artificial stone is used as floor tile or in the form of a slab, for example a table slab, the flat structure claimed can have a thickness which is particularly preferably in the range from 0.2 cm to 5 cm. Depending on the application, the layer thickness of the novel artificial stone can have a lower limit of 0.2 cm, with upper limits of up to 100 cm, preferably from 0.5 to 10 cm and particularly preferably from 0.6 to 5.0 cm, likewise being suitable.

Apart from the floor tile itself, the present invention also encompasses the use thereof in the building chemical sector and in particular for assembly halls and commercial buildings in the electronics and electrical industry. In addition, the artificial stone claimed is suitable for flat structures for buildings and quite generally for fields of application which are associated with hazards due to electrostatic charges and which therefore also require special explosion protection.

Overall, the artificial stone described for flat structures is characterized in that it no longer acquires any significant electrostatic charge and can, in particular, be matched precisely to the respective use by means of a fitting combination of the additives present therein with further conductive components. Owing to the specific constituents, this artificial stone can be produced inexpensively and can also be used in fields of application for which only thin-layer surface coatings have hitherto appeared to be suitable.

The present invention further also provides the artificial stone adhesive, plaster or grouting mortar which may optionally contain the antistatically acting composition composed of ionic liquid and optionally metal salt in addition to the abraded solid used in the flat structures.

The abraded solid to be used for the artificial stone and optionally also for the artificial stone adhesive, plaster or grouting mortar has a particle size in the range from 0.001 mm to 20 mm, preferably from 0.01 mm to 5 mm.

The following examples illustrate the advantages of the present invention.

Further embodiments of the teachings of the invention may be found in the claims, whose disclosure content is fully incorporated by reference into the present description.

The invention is further described by the following non-limiting examples which further illustrate the invention, and are not intended, nor should they be interpreted to, limit the scope of the invention.

### Experimental Part:

The examples described serve merely for the purposes of illustration and do not restrict the subject matter of the invention in any way. Percentages or parts are by weight unless specifically indicated otherwise.

### EXAMPLES

In the formulations 1 and 2 according to the invention, antistatic additives of the following composition were used:

The mixture of ionic liquid, conductive salt (and organic solvent) was produced with the aid of a magnetic stirrer. In the case of antistatic 1, the component ethylbis(polyethoxyethanol)tallowalkylammonium ethylsulphate (Tego® IL T16ES) as ionic liquid was mixed with an equimolar amount of calcium thiocyanate as conductive salt. As antistatic 2, use was made of an equimolar mixture comprising 1,3-dimethylimidazolium methylsulphate as ionic liquid and lithium bis(trifluoromethylsulphonyl)imide as conductive salt. The mixture of ionic liquid and metal salt can have a stronger antistatic action than the components separately in otherwise equimolar ratios. In these cases, a synergistic effect and correspondingly a synergistic mixture is present.

The antistatic formulation is added to the mixture before thermal curing or added with kneading to the polymer mixture after melting.

### Formulation 1:

78% by weight of abraded marble
15% by weight of polyester resin (consisting of 98 parts of polyester resin and 2 parts of meth(acryl)oxypropyltrimethoxysilane (MEMO))
5% by weight of pigments
2% by weight of antistatic additive

All components are mixed together in a kneader and kneaded to form a homogeneous composition before curing of the polyester resin. The composition is then poured out and spread over an area, if appropriate with the aid of (casting) moulds and, if appropriate, smoothed on the surface.

After curing, the flat structure can be cut into a tile or slab form.

The conductivity was significantly increased, or the surface resistance was significantly decreased, compared to a sample produced without addition of the antistatic additive.

### Formulation 2:

77% by weight of abraded granite
15% by weight of polyester resin (consisting of 98 parts of polyester resin and 2 parts of MEMO)
5% by weight of pigments
3% by weight of antistatic additive

All components are mixed together in a kneader and kneaded to form a homogeneous composition before curing of the polyester resin. The composition is then poured out and spread over an area, if appropriate with the aid of (casting) moulds and, if appropriate, smoothed on the surface.

After curing, the flat structure can be cut into a tile or slab form.

The conductivity was significantly increased, or the surface resistance was significantly decreased, compared to a sample produced without addition of the antistatic additive.

### Comparative Formulation:

80% by weight of abraded granite
15% by weight of polyester resin (consisting of 98 parts of polyester resin and 2 parts of MEMO)
5% by weight of pigments

All components are mixed together in a kneader and kneaded to form a homogeneous composition before curing of the polyester resin. The composition is then poured out and spread over an area, if appropriate with the aid of (casting) moulds and, if appropriate, smoothed on the surface.

After curing, the flat structure can be cut into a tile or slab form.

The conductivity was significantly lower, or the surface resistance was significantly higher, compared to a sample produced with addition of the antistatic additive.

Having thus described in detail various embodiments of the present invention, it is to be understood that the invention defined by the above paragraphs is not to be limited to particular details set forth in the above description as many apparent variations thereof are possible without departing from the spirit or scope of the present invention.

1. An artificial stone for flat structures comprising of a constituent matrix and a polymer matrix, characterized in that it contains an antistatic formulation comprising at least one ionic liquid or solutions of metal salts in ionic liquids.

2. The artificial stone for flat structures according to claim 1, characterized in that the ionic liquid comprises at least one cation of the general formulae (IV), (V), (VI), (VII) or (VIII),
R¹R²R³R⁴N⁺ (IV)
R¹R²N⁺═CR³R⁴ (V)
R¹R²R³R⁴P⁺ (VI)
R¹R²P⁺═CR³R⁴ (VII)
R¹R²R³S⁺ (VIII)
where R¹, R², R³, R⁴ are identical or different and are each hydrogen, a linear or branched aliphatic hydrocarbon radical which has from 1 to 30 carbon atoms and may contain double bonds, a cycloaliphatic hydrocarbon radical which has from 5 to 40 carbon atoms and may contain double bonds, an aromatic hydrocarbon radical having from 6 to 40 carbon atoms, an alkylaryl radical having from 7 to 40 carbon atoms, a linear or branched aliphatic hydrocarbon radical which has from 2 to 30 carbon atoms and is interrupted by one or more heteroatoms (O, NH, NR′ where R′ is a C₁-C₃₀-alkyl radical which may contain double bonds, in particular —CH₃) and may contain double bonds, a linear or branched aliphatic hydrocarbon radical which has from 2 to 30 carbon atoms and is interrupted by one or more functions selected from the group consisting of —O—C(O)—, —(O)C—O—, —NH—C(O)—, —(O)C—NH, —(CH₃)N—C(O)—, —(O)C—N(CH₃)—, —S(O₂)—O—, —O—S(O₂)—, —S(O₂)—NH—, —NH—S(O₂)—, —S(O₂)—N(CH₃)—, —N(CH₂)—S(O₂)— and may contain double bonds, a linear or branched aliphatic or cycloaliphatic hydrocarbon radical which has from 1 to 30 carbon atoms and is terminally functionalised by OH, OR′, NH₂, N(H)R′, N(R′)₂, where R′ is a C₁-C₃₀-alkyl radical which may contain double bonds, and may contain double bonds, or a block or random polyether according to —(R⁵—O)ₙ—R⁶, where R⁵ is a linear or branched hydrocarbon radical containing from 2 to 4 carbon atoms, n is from 1 to 100, and R⁶ is hydrogen, a linear or branched aliphatic hydrocarbon radical which has from 1 to 30 carbon atoms and may contain double bonds, a cycloaliphatic hydrocarbon radical which has from 5 to 40 carbon atoms that may contain double bonds, an aromatic hydrocarbon radical having from 6 to 40 carbon atoms, an alkylaryl radical having from 7 to 40 carbon atoms or a radical —C(O) —R⁷ where R⁷ is a linear or branched aliphatic hydrocarbon radical which has from 1 to 30 carbon atoms that may contain double bonds, a cycloaliphatic hydrocarbon radical which has from 5 to 40 carbon atoms and may contain double bonds, an aromatic hydrocarbon radical having from 6 to 40 carbon atoms, an alkylaryl radical having from 7 to 40 carbon atoms.

3. The artificial stone for flat structures according to claim 2, characterized in that the ionic liquids contain at least one cation of the general formulae (XIII), (XIV) and (XV), where the heterocyclic rings may also contain a plurality of heteroatoms 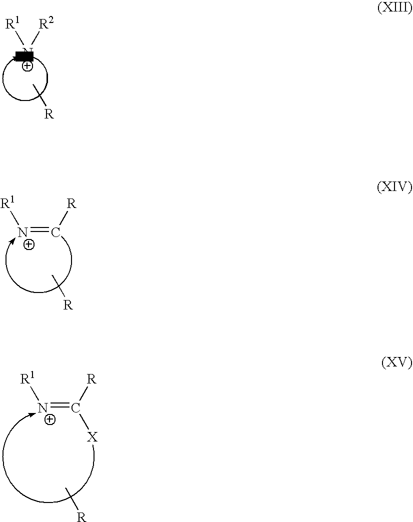
R¹ and R² have the abovementioned meanings,
R is hydrogen, a linear or branched aliphatic hydrocarbon radial which has from 1 to 30 carbon atoms and may contain double bonds, a cycloaliphatic hydrocarbon radical which has from 5 to 40 carbon atoms and may contain double bonds, an aromatic hydrocarbon radical having from 6 to 40 carbon atoms or an alkylaryl radical having from 7 to 40 carbon atoms,
X is an oxygen atom, a sulphur atom or a substituted nitrogen atom (X═O, S, NR¹).

4. The artificial stone for flat structures according to claim 2, characterized in that the ionic liquids comprise at least one cation of the general formula (XVI) in which R⁸, R⁹, R¹⁰, R¹¹, R¹² are identical or different and are each hydrogen, a linear or branched aliphatic hydrocarbon radical which has from 1 to 30 carbon atoms and may contain double bonds, a cycloaliphatic hydrocarbon radical which has from 5 to 40 carbon atoms and may contain double bonds, an aromatic hydrocarbon radical having from 6 to 40 carbon atoms, an alkylaryl radical having from 7 to 40 carbon atoms, a linear or branched aliphatic hydrocarbon radical which has from 1 to 30 carbon atoms and is interrupted by one or more heteroatoms (O, NH, NR′ where R′ is a C₁-C₃₀-alkyl radical which may contain double bonds) and may contain double bonds, a linear or branched aliphatic hydrocarbon radical which has from 1 to 30 carbon atoms and is interrupted by one or more functions selected from the group consisting of —O—C(O)—, —(O)C—O—, —NH—C(O)—, —(O)C—NH, —(CH₃)N—C(O)—, —(O)C—N(CH₃)—, —S(O₂)—O—, —O—S(O₂)—, —S(O₂)—NH—, —NH—S(O₂)—S(O₂)—N(CH₃)—, —N(CH₃)—S(O₂)— and may contain double bonds, a linear or branched aliphatic or cycloaliphatic hydrocarbon radical which has from 1 to 30 carbon atoms and is terminally functionalised by OH, OR′, NH₂, N(H)R′, N(R′)₂ where R′ is a C₁-C₃₀-alkyl radical which may contain double bonds, and may contain double bonds, or a block or random polyether made up of —(R⁵—O)ₙ—R⁶, where R⁵ is a hydrocarbon radical containing from 2 to 4 carbon atoms, n is from 1 to 100, and R⁶ is hydrogen, a linear or branched aliphatic hydrocarbon radical which has from 1 to 30 carbon atoms and may contain double bonds, a cycloaliphatic hydrocarbon radical which has from 5 to 40 carbon atoms that may contain double bonds, an aromatic hydrocarbon radical having from 6 to 40 carbon atoms, an alkylaryl radical having from 7 to 40 carbon atoms or a radical —C(O)—R⁷ where R⁷ is a linear or branched aliphatic hydrocarbon radical which has from 1 to 30 carbon atoms that may contain double bonds, a cycloaliphatic hydrocarbon radical which has from 5 to 40 carbon atoms and may contain double bonds, an aromatic hydrocarbon radical having from 6 to 40 carbon atoms or an alkylaryl radical having from 7 to 40 carbon atoms.

5. The artificial stone for flat structures according to claim 2, characterized in that the ionic liquids contain at least one anion selected from the group consisting of halides, bis(perfluoroalkylsulphonyl)amides and bis(perfluoroalkyl-sulphonyl)imides, bis(trifluoromethylylsulphonyl)imide, alkyltosylates and aryltosylates, perfluoroalkyltosylates, nitrate, sulphate, hydrogensulphate, alkylsulphates and arylsulphates, polyether sulphates and/or polyether sulphonates, perfluoroalkylsulphates, sulphonate, alkylsulphonates and arylsulphonates, perfluorinated alkylsulphonates and arylsulphonates, alkylcarboxylates and arylcarboxylates, perfluoroalkylcarboxylates, perchlorate, tetrachloroaluminate, saccharinate, anions of the compounds dicyanamide, thiocyanate, isothiocyanate, tetraphenylborate, tetrakis(pentafluorophenyl)borate, tetrafluoroborate, hexafluorophosphate, polyetherphosphates and/or phosphates.

6. The artificial stone for flat structures according to claim 2, characterized in that the ionic liquids contain at least one cation selected from the group consisting of 1,3-dialkylimidazolium, 1,2,3-trialkylimidazolium, 1,3-dialkylimidazolinium and/or 1,2,3-trialkylimidazolinium cations and at least one anion selected from the group consisting of halides, bis(trifluoromethylylsulphonyl)imide, perfluoroalkyltosylates, alkylsulphates and alkylsulphonates, perfluorinated alkylsulphonates and alkylsulphates, perfluoroalkylcarboxylates, perchlorate, dicyanamide, thiocyanate, isothiocyanate, tetraphenylborate, tetrakis(pentafluorophenyl)borate, tetrafluoroborate, hexafluorophosphate and/or acyclic quaternary ammonium salts.

7. The artificial stone for flat structures according to claim 2, characterized in that the ionic liquids contain at least one additive in the form of a compound which improves the solubility of the cation or a complexing agent, in particular a crown ether or a cryptand thereof and/or EDTA.

8. The artificial stone for flat structures according to claim 2, characterized in that at least one metal salt selected from the group consisting of the alkali metal salts of the anions: bis(perfluoroalkylsulphonyl)amide and bis(perfluoroalkylsulphonyl)imide, bis(trifluoromethylsulphonyl)imide, alkyltosylates and aryltosylates, perfluoroalkyltosylates, nitrate, sulphate, hydrogensulphate, alkylsulphates and arylsulphates, polyether sulphates and polyether sulphonates, perfluoroalkylsulphates, sulphonate, alkylsulphonates and arylsulphonates, perfluorinated alkylsulphonates and arylsulphonates, alkylcarboxylates and arylcarboxylates, perfluoroalkylcarboxylates, perchlorate, tetrachloroaluminate, saccharinate, thiocyanate, isothiocyanate, dicyanamide, tetraphenylborate, tetrakis(pentafluorophenyl)borate, tetrafluoroborate, hexafluorophosphate, phosphate and/or polyetherphosphate is dissolved in the ionic liquids.

9. The artificial stone for flat structures according to claim 2, characterized in that the polymer matrix comprises at least one polyurethane, epoxy resin, polyester resin, acrylate, methacrylate and/or vinyl ester.

10. The artificial stone for flat structures according to claim 2, characterized in that the artificial stone comprises abraded solid as a constituent.

11. The artificial stone for flat structures according to claim 10, characterized in that the abraded solid comprises solid, naturally occurring or synthetically produced, optionally microscopically heterogeneous compositions composed of minerals, fragments of rock, glasses or residues of organisms or synthetically produced rocks or else glass, porcelain and ceramic in comminuted form or plastics, used either alone or in any mixtures with one another.

12. The artificial stone for flat structures according to claim 2, characterized in that the polymer matrix contains fillers and/or pigments, conductive materials, carbon fibres, graphite, carbon black, metal (alloy) oxides and/or fillers coated with conductive materials and/or pigments.

13. The artificial stone for flat structures according to claim 2, characterized in that the antistatic component is present in amounts in the range from 0.01 to 30% by weight.

14. The artificial stone for flat structures according to claim 2, characterized in that it has a thickness of up to 10 cm.

15. The artificial stone according to claim 11, characterized in that its specific surface resistance is less than 10¹⁰ ohm.

16. A method of reducing electrostatic charges which comprises of applying the artificial stone of claim 1 to a surface.

17. A table slab which is covered by the artificial stone according to claim 1.

18. A table slab comprising artificial stone according to claim 1.

19. A process for producing artificial stone according to claim 1, characterized in that the antistatic formulation comprising at least one ionic liquid and optionally at least one metal salt is kneaded together with the abraded solid before curing of the polymer matrix or in the case of thermoplastic polymers is incorporated by melting.

20. A method for antistatically treating an artificial stone adhesive, plaster, grouting mortar or tile adhesive which comprises of adding at least one ionic liquid or/and a solution of a metal salt in an ionic liquid and optionally abraded solid to said artificial stone adhesive, plaster, grouting mortar or tile adhesive.
